(19) United States
(12) Patent Application Publication
(10) Pub. No.: US 2026/0101348 A1
(43) Pub. Date: Apr. 9, 2026

(54) RESOURCE MUTING FOR UL TRANSMISSION IN WIRELESS COMMUNICATION SYSTEMS

(71) Applicant: Samsung Electronics Co., Ltd., Suwon-si (KR)

(72) Inventors: Marian Rudolf, Longueuil (CA); Eko Onggosanusi, Coppell, TX (US)

(21) Appl. No.: 19/334,720

(22) Filed: Sep. 19, 2025

Related U.S. Application Data
(60) Provisional application No. 63/703,017, filed on Oct. 3, 2024.

(51) Int. Cl. H04W 72/21; H04W 72/0446

(52) U.S. Cl. CPC H04W 72/21; H04W 72/0446

(57) ABSTRACT

Apparatuses and methods for uplink (UL) transmission in wireless communication systems. A method for a user equipment (UE) to transmit a physical UL shared channel (PUSCH) includes receiving first information indicating resources for resource element (RE) muting, identifying whether second information associated with a subband full duplex (SBFD) configuration of a serving cell is provided, and identifying whether a parameter is provided. The parameter is ulMutingNonSBFDSymbol. The method further includes determining whether the parameter is enabled and transmitting the PUSCH based on the first information in an SBFD symbol when the parameter is not provided or disabled and in an SBFD or non-SBFD symbol when the parameter is enabled.

### CROSS REFERENCE TO RELATED APPLICATIONS AND CLAIM OF PRIORITY

The present application claims priority under 35 U.S. C. § 119(e) to U.S. Provisional Ser. No. 63/703,017 filed on Oct. 3, 2024, which is hereby incorporated by reference in its entirety.

### TECHNICAL FIELD

The present disclosure relates generally to wireless communication systems and, more specifically, the present disclosure is related to apparatuses and methods for resource muting for uplink (UL) transmission in wireless communication systems.

### BACKGROUND

6th generation (6G) is recently gathering increased momentum with all the worldwide technical activities on the various candidate technologies from industry and academia. The candidate enablers for the 6G mobile communications include massive antenna technologies, from legacy cellular frequency bands up to high frequencies, to provide beamforming gain and support increased capacity, waveform design to flexibly accommodate various services/applications with different requirements, new multiple access schemes to support massive connections, AI/ML, and so on.

### SUMMARY

The present disclosure relates to resource muting for UL transmission in wireless communication systems.

In one embodiment, a method for a user equipment (UE) to transmit a physical uplink shared channel (PUSCH) is provided. The method includes receiving first information indicating resources for resource element (RE) muting, identifying whether second information associated with a subband full duplex (SBFD) configuration of a serving cell is provided, and identifying whether a parameter is provided, wherein the parameter is ulMutingNonSBFD-Symbol. The method further includes determining whether the parameter is enabled and transmitting the PUSCH based on the first information in an SBFD symbol when the parameter is not provided or disabled and in an SBFD or non-SBFD symbol when the parameter is enabled.

In another embodiment, a UE is provided. The UE includes a transceiver configured to receive first information indicating resources for RE muting and a processor operably coupled with the transceiver. The processor is configured to identify whether second information associated with a SBFD configuration of a serving cell is provided, identify whether a parameter is provided, wherein the parameter is ulMutingNonSBFD-Symbol, and determine whether the parameter is enabled. The transceiver is further configured to transmit a PUSCH based on the first information in an SBFD symbol when the parameter is not provided or disabled and in an SBFD or non-SBFD symbol when the parameter is enabled.

In yet another embodiment, a base station (BS) is provided. The BS includes a transceiver configured to transmit first information indicating resources for RE muting and a processor operably coupled with the transceiver. The processor is configured to identify whether second information associated with a SBFD configuration of a serving cell is provided, identify whether a parameter is provided, wherein the parameter is ulMutingNonSBFDSymbol, and determine whether the parameter is enabled. The transceiver is further configured to receive a PUSCH based on the first information in an SBFD symbol when the parameter is not provided or disabled and in an SBFD or non-SBFD symbol when the parameter is enabled.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a timeline of an example time division duplexing (TDD) configuration according to embodiments of the present disclosure;

FIG. 11 illustrates timelines of example full-duplex (FD) configurations according to embodiments of the present disclosure;

FIG. 12 illustrates an example transparent resource muting pattern according to embodiments of the present disclosure;

FIG. 13 illustrates an example non-transparent resource muting pattern according to embodiments of the present disclosure;

FIG. 14 illustrates a flowchart of an example UE procedure for transmitting PUSCH according to embodiments of the present disclosure;

FIG. 15 illustrates a flowchart of an example UE procedure for transmitting PUSCH according to embodiments of the present disclosure;

FIG. 16 illustrates a flowchart of an example UE procedure for transmitting PUSCH according to embodiments of the present disclosure;

FIG. 17 illustrates a timeline of an example UL muting pattern according to embodiments of the present disclosure; and

FIG. 18 illustrates an example method performed by a UE in a wireless communication system according to embodiments of the present disclosure.

### DETAILED DESCRIPTION

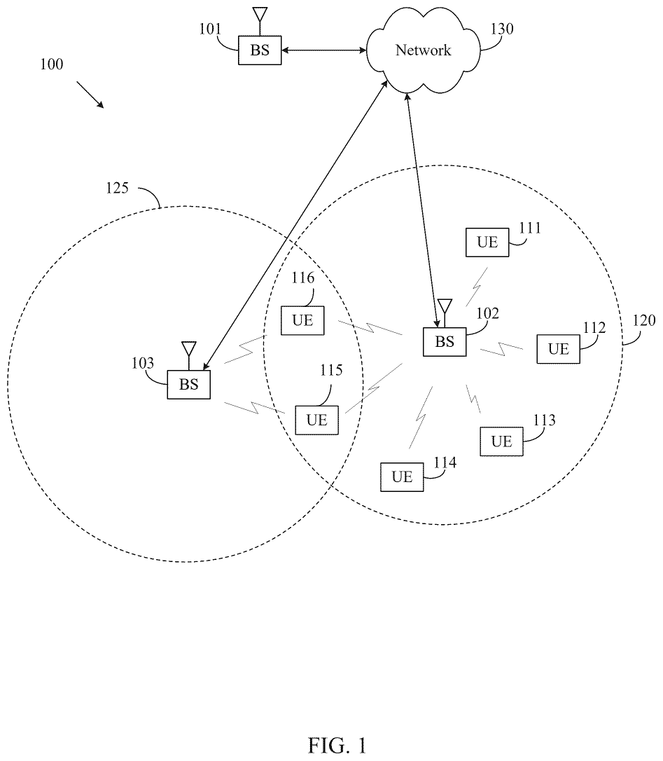

FIGS. 1-18 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G/LTE communication systems, and to enable various vertical applications, 5G/NR communication systems have been developed and are currently being deployed. The 5G/NR communication system can be implemented in higher frequency (mmWave) bands, e.g., 23-39 GHz or 60 GHz bands, so as to accomplish higher data rates or in lower frequency bands, such as 3.7/3.8 GHz, to enable robust coverage and mobility support. 6th generation (6G) cellular communications is recently gathering increased momentum with the worldwide technical activities on the various candidate technologies from industry and academia. The candidate enablers for the 6G communication system include massive antenna technologies, from cellular frequency bands up to high frequencies, to provide beamforming gain and support increased capacity, waveform design to flexibly accommodate various services/applications with different requirements, new multiple access schemes to support massive connections, AI/ML, and so on

The discussion of 6G systems and frequency bands associated therewith is for reference as certain embodiments of the present disclosure may be implemented in 6G systems. However, the present disclosure is not limited to 6G systems, or the frequency bands associated therewith, and embodiments of the present disclosure may be utilized in connection with any frequency band. For example, aspects of the present disclosure may also be applied to deployment of 6G communication systems, to deployment of 5G/NR communication systems, to deployment of 4G/LTE communication systems, or even for deployments which may use terahertz (THz) bands in later releases.

The following documents and standards descriptions are hereby incorporated by reference into the present disclosure as if fully set forth herein: 3GPP TS 38.211 v18.3.0, “NR; Physical channels and modulation” (REF1); 3GPP TS 38.212 v18.3.0, “NR; Multiplexing and Channel coding” (REF2); 3GPP TS 38.213 v18.3.0, “NR; Physical Layer Procedures for Control” (REF3); 3GPP TS 38.214 v18.3.0, “NR; Physical Layer Procedures for Data” (REF4); 3GPP TS 38.321 v18.2.0, “NR; Medium Access Control (MAC) protocol specification” (REF5); 3GPP TS 38.331 v18.2.0, “NR; Radio Resource Control (RRC) Protocol Specification” (REF6); 3GPP TS 38.101-1 v18.6.0, “NR; UE radio transmission and reception; Part 1: Range 1 Standalone” (REF7); 3GPP TS 38.101-2 v18.6.0, “NR; UE radio transmission and reception; Part 2: Range 2 Standalone” (REF8); 3GPP TS 38.101-3 v18.6.0, “NR; UE radio transmission and reception; Part 3: Range 1 and Range 2 Interworking operation with other radios” (REF9); and 3GPP TS 38.133 v18.6.0, “NR; Requirements for support of radio resource management”(REF10).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 6G, 5G/new radio (NR), 4G/long term evolution (LTE) or long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6G base station, a macrocell, a femtocell, a WiFi access point (AP), or other wirelessly enabled devices. Base stations may provide wireless access in accordance with one or more wireless communication protocols, e.g., 6G, 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or a vending machine or a fixed wireless access node).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing resource muting for UL transmission in wireless communication systems. In certain embodiments, one or more of the BSs 101-103 include circuitry, programing, or a combination thereof to support resource muting for UL transmission in wireless communication systems. Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

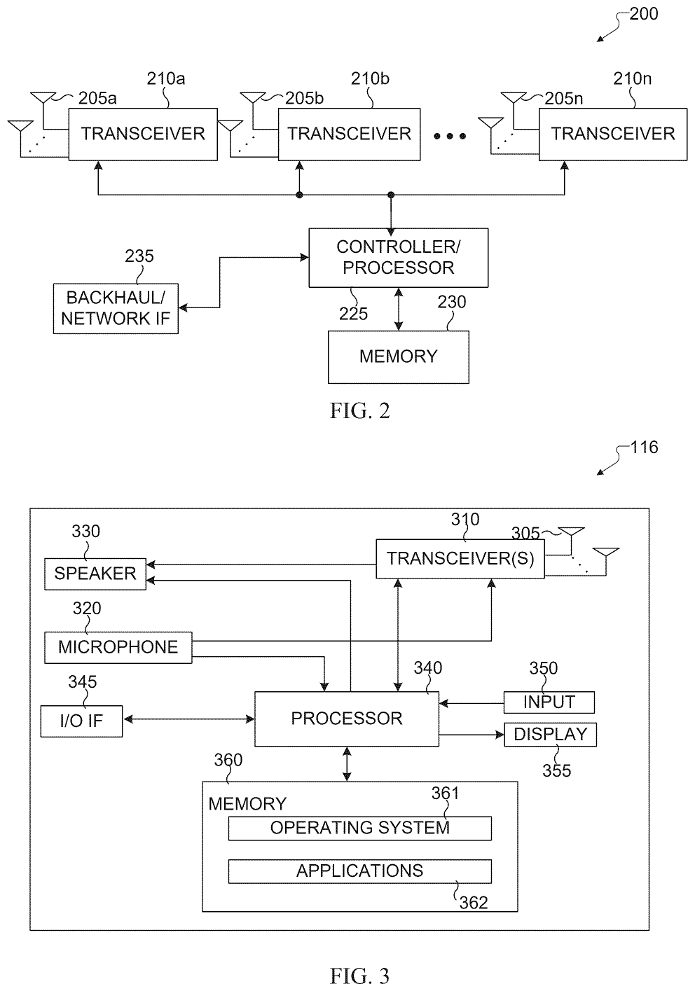

FIG. 2 illustrates an example TRP 200 according to embodiments of the present disclosure. For example, the TRP 200 any be a base station, such as gNB 101-103, or may be an NCR or smart repeater (SR). The embodiment of the TRP 200 illustrated in FIG. 2 is for illustration only. However, TRPs come in a wide variety of configurations, and FIG. 2 does not limit the scope of the present disclosure to any particular implementation of a TRP.

As shown in FIG. 2, the TRP 200 includes multiple antennas 205a-205n, multiple transceivers 210a-210n, a controller/processor 225, a memory 230, and a backhaul or network interface 235. The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

For example, in embodiments where the TRP is a repeater, one or more of the transceivers 210 may be used for an NCR-RU entity or NCR-Fwd entity as a DL connection for signaling over an access link with a UE and/or over a backhaul link with a gNB. In these examples, the associated one(s) of the transceivers 210 for the NCR-RU entity or NCR-Fwd entity may not covert the incoming RF signal to IF or a baseband signal but rather amplify the incoming RF signal and forward or relay the amplified signal, without any down conversion to IF or baseband. In another example, in embodiments where the TRP is a repeater, one or more of the transceivers 210 may be used for an NCR-MT entity as a DL or UL connection for control signaling over a control link (C-link) with a gNB.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the TRP 200. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for transmission power in wireless communication systems. Any of a wide variety of other functions could be supported in the TRP 200 by the controller/processor 225.

The controller/processor 225 is also capable of executing programs and other processes resident in the memory 230, such as processes to support resource muting for UL transmission in wireless communication systems. The controller/processor 225 can move data into or out of the memory 230 as required by an executing process.

The controller/processor 225 is also coupled to the backhaul or network interface 235. The backhaul or network interface 235 allows the TRP 200 to communicate with other devices or systems over a backhaul connection or over a network. The interface 235 could support communications over any suitable wired or wireless connection(s). For example, when the TRP 200 is implemented as part of a cellular communication system (such as one supporting 6G, 5G/NR, LTE, or LTE-A), the interface 235 could allow the TRP 200 to communicate with other gNBs over a wired or wireless backhaul connection, for example, using a transceiver, such as described herein with regard to transceivers 210. For example, in embodiments where the TRP is a repeater, the interface 235 may be used for an NCR-RU or NCR-Fwd entity as a backhaul connection with a gNB over a backhaul link for control signaling and/or data to be transmitted to and/or received from a UE. When the TRP 200 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of TRP 200, various changes may be made to FIG. 2. For example, the TRP 200 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for resource muting for UL transmission in wireless communication systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

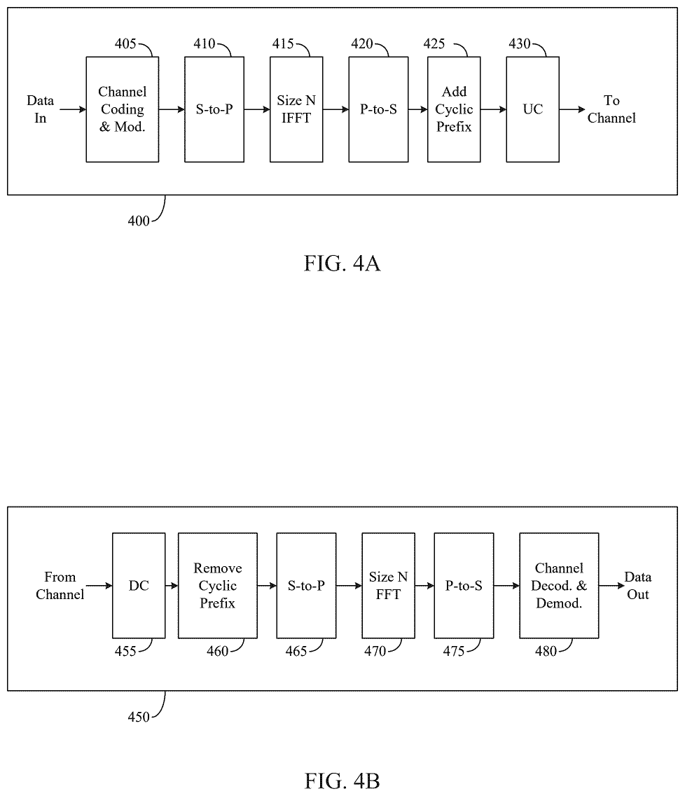

FIG. 4A and FIG. 4B illustrate an example of wireless transmit and receive paths 400 and 450, respectively, according to embodiments of the present disclosure. For example, a transmit path 400 may be described as being implemented in a gNB or TRP (such as gNB 102 or TRP 200), while a receive path 450 may be described as being implemented in a UE (such as UE 116). However, it will be understood that the receive path 450 can be implemented in a gNB or TRP and that the transmit path 400 can be implemented in a UE. In some embodiments, the transmit path 400 and/or the receive path 450 is configured for resource muting for UL transmission in wireless communication systems as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 or the TRP 200 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 or the TRP 200 and may implement a receive path 450 for receiving in the downlink from gNBs 101-103 or the TRP 200.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

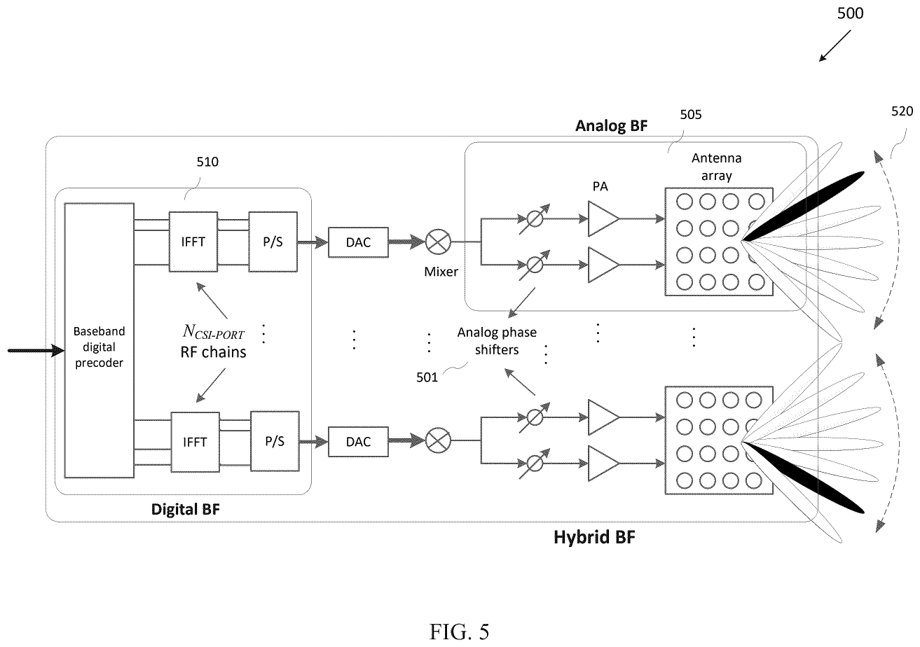

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

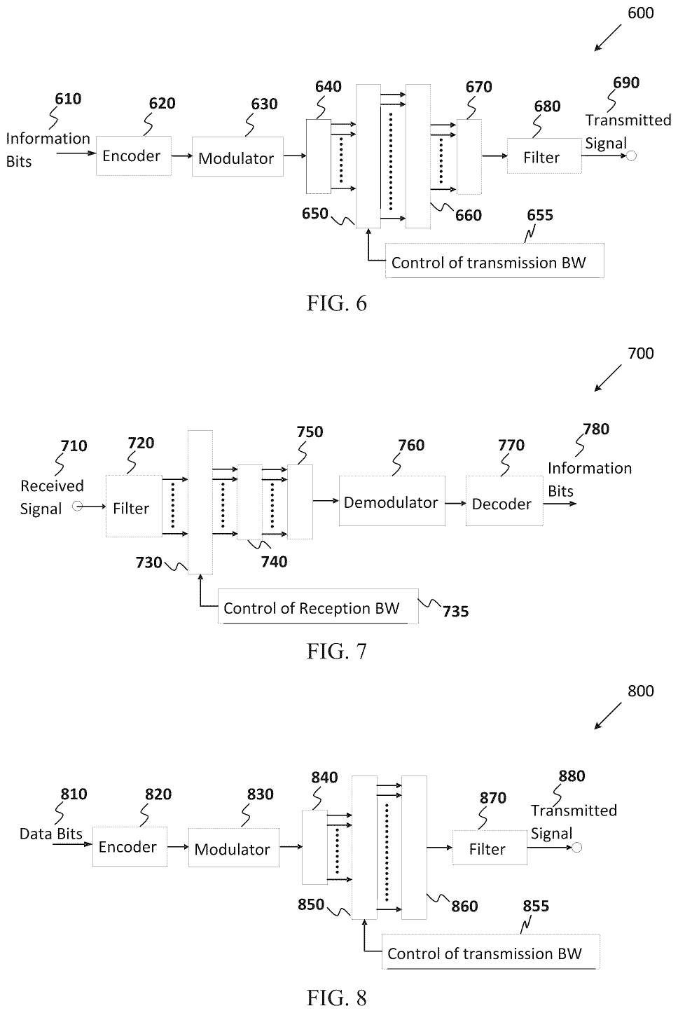

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a demodulation reference signal (DMRS) or a CRS (not shown), and a decoder 770, such as a turbo decoder or a low-density-parity-check (LDPC) decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

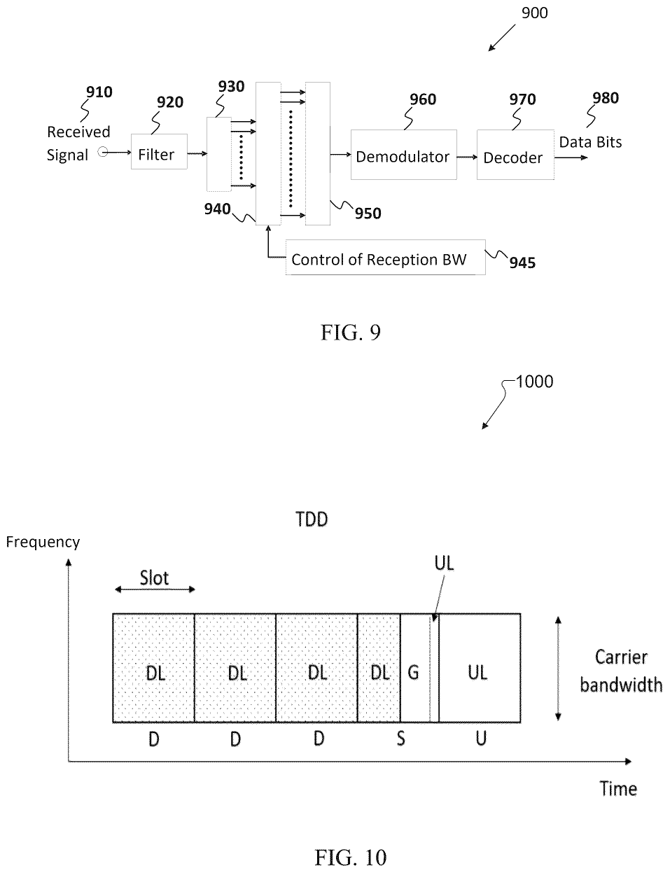

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder or a low-density-parity-check (LDPC) decoder, decodes the demodulated data to provide an estimate of the information data bits 980.

The present disclosure relates generally to wireless communication systems and, more specifically, to UE procedures for resource muting for UL transmissions in a wireless communication system.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency or bandwidth (BW) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with cyclic redundancy check (CRC) scrambled by cell-radio network temporary identifier (C-RNTI/configured scheduling RNTI (CS-RNTI)/modulation and coding scheme (MCS)-C-RNTI as described in REF2, are referred for brevity as a unicast DCI format. A DCI format scheduling PDSCH reception for multicast communication, such as a DCI format with CRC scrambled by group (G)-RNTI/G-CS-RNTI as described in REF2, are referred to as multicast DCI format. DCI formats providing various control information to at least a subset of UEs in a serving cell, such as DCI format 2_0 in REF2, are referred to as group-common (GC) DCI formats.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA. A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channel (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or channel state information reference signal (CSI-RS) and a target reference signal, or a spatial relationship information that establishes an association to a source reference signal, such as an SSB, CSI-RS, or sounding reference signal (SRS). In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the gNB, or a spatial Rx filter for reception of uplink channels or signals at the gNB.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

A quasi-co-location (QCL) relationship may be configured by the higher layer parameter qcl-Type1 for a first DL RS, and qcl-Type2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}. A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is N_{DJ}. UL TCI states are configured by higher layer parameter UL-TCIState, wherein the number of UL TCI states is N_{U}. N=N_{DJ}+N_{U}. The DLorJoint-TCIState can include DL or Joint TCI states for a serving cell. The source RS of the TCI state may be associated with the serving cell, e.g., the physical cell ID (PCI) of the serving cell. Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell); additionally, the UL TCI states can be associated with a cell having a PCI different from the PCI of the serving cell, e.g., the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2^{m}. The TCI state may correspond to a code point signaled by MAC CE. A DCI used for indication of the TCI state can be a DCI format 1_1 or DCI format 1_2 or DCI format 1_3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS and the CSI-RS has the SSB as its source, e.g., for a QCL Type D relation or a spatial relation. The indirect QCL relation to an SSB can involve a QCL or spatial relation chain of more than one CSI-RS.

In the present disclosure, the frequency resolution (reporting granularity) and span (reporting bandwidth) of CSI or calibration coefficient reporting can be defined in terms of frequency “subbands”and “CSI reporting band”(CRB), respectively.

A subband for CSI or calibration coefficient reporting is defined as a set of contiguous physical resource blocks (PRBs) which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include the subbands within the DL system bandwidth. This can also be termed “full-band”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for the Mₙ subbands within the CSI reporting band. A CSI parameter is configured with “subband” for the CSI reporting band with Mn subbands when one CSI parameter is reported for each of the Mn subbands within the CSI reporting band.

In certain embodiments, 5G NR radio supports time-division duplex (TDD) operation and frequency division duplex (FDD) operation. Use of FDD or TDD depends on the NR frequency band and per-country allocations. TDD is required in most bands above 2.5 GHz.

FIG. 10 illustrates a timeline 1000 of an example TDD configuration according to embodiments of the present disclosure. For example, timeline 1000 can be followed by any of the UEs 111-116 of FIG. 1 and the gNB 102 and/or network 130 in the wireless network 100 of FIG. 1. This example is for illustration only and other embodiments can be used without departing from the scope of the present disclosure.

With reference to FIG. 10, a DDDSU UL-DL configuration is shown in FIG. 10. Here, D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL taking into account an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the smaller portion of time resources available for transmissions from a UE, while with FDD time resources can be used. Another disadvantage is latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network (e.g., the network 130) to forgo HARQ-ACK information at least for some transport blocks in the DL).

To address some of the disadvantages for TDD operation, an adaptation of link direction based on physical layer signaling using a DCI format is supported where, with the exception of some symbols in some slots supporting predetermined transmissions such as for SSBs, symbols of a slot can have a flexible direction (UL or DL) that a UE can determine according to scheduling information for transmissions or receptions. A PDCCH can also be used to provide a DCI format, such as a DCI format 2_0 as described in REF3, that can indicate a link direction of some flexible symbols in one or more slots. Nevertheless, in actual deployments, it is difficult for a gNB scheduler to adapt a transmission direction of symbols without coordination with other gNB schedulers in the network. This is because of cross link interference (CLI) where, for example, DL receptions in a cell by a UE can experience large interference from UL transmissions in the same or neighboring cells from other UEs.

Full-duplex (FD) communications offer a potential for increased spectral efficiency, improved capacity, and reduced latency in wireless networks. When using FD communications, UL and DL signals are simultaneously received and transmitted on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. For example, transmissions and receptions on same symbols or slots may be separated in frequency by being placed in non-overlapping sub-bands. For example, transmission and receptions on a same symbol or slot using FD communications may occur with or without a sub-band such as when a subcarrier (SC), or a resource block (RB), or a resource block group (RBG) of a transmission is used for a simultaneous reception. An UL frequency sub-band, in time-domain resources that also include DL frequency sub-bands, may be located in the center of a carrier, or at the edge of the carrier, or at a selected frequency-domain position of the carrier. For example, the allocations of DL sub-bands and UL sub-bands may also partially or even fully overlap.

A gNB (e.g., the BS 102) may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE (e.g., the UE 116) receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot. FD operation using an UL subband or a DL subband wherein at least from the UE perspective a DL reception in a DL subband and an UL transmission in an UL subband may occur in non-overlapping subbands may be referred to as SBFD. FD operation wherein at least from the gNB perspective a DL transmission or UL reception may occur in partially or fully overlapped frequency-domain resources may be referred to as single-frequency full-duplex (SFFD) or in-band full-duplex (IBFD). For example, SFFD or IBFD operation may or may not use an UL subband or a DL subband.

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two DL subbands and one UL subband on the full-duplex slot or symbol. A frequency-domain configuration of the DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbol and non-full-duplex slots/symbols and normal DL or UL slot/symbols may be referred to as non-SBFD slots/symbols. For example, a slot/symbol configured as U by TDD-UL-DL-ConfigCommon in SIB1 or parameter ServingCellConfigCommon may be referred to as “non-SBFD” slot/symbol or as “normal” UL slot/symbol. For example, a slot/symbol configured as D and/or F by TDD-UL-DL-ConfigCommon in SIB1 or parameter ServingCellConfigCommon may be referred to as “SBFD”slot/symbol.

Instead of using a single carrier, different component carriers (CCs) can be used for receptions and transmissions by a UE. For example, receptions by a UE can occur on a first CC and transmissions by the UE occur on a second CC having a small, including zero, frequency separation from the first CC. For example, the component carriers may be provided to the UE using intra-band contiguous or non-contiguous or inter-band carrier aggregation. For example, when carrier-aggregation based full-duplex operation is used, an SBFD subband may correspond to a component carrier or a part of a component carrier or an SBFD subband may be allocated using parts of multiple component carriers. Instead of using a single carrier, different bandwidth parts (BWPs) can be used for receptions and transmissions by a UE. For example, receptions by a UE can occur on a first BWP and transmissions by the UE occur on a second BWP having a small, including zero, frequency separation from the first BWP. For example, when BWP based full-duplex operation is used, an SBFD subband may correspond to a BWP or a part of a BWP or an SBFD subband may be allocated using parts of multiple BWPs.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can transmit or receive but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation or based on the use of BWPs.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by a UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers.

In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support. For example, the SBFD-aware UE may operate according to the Rel-19 NR Duplex enhancements feature. In the following, for brevity, a UE (e.g., the UE 116) operating in full-duplex mode may be referred to as SBFD-capable UE, or as full-duplex capable UE, or as a full-duplex UE. A full-duplex UE may support a number of enhancements for gNB-side full-duplex operation. For example, the SBFD-capable UE may support time-domain or frequency-domain resource allocation enhancements to improve the UL coverage or throughput or spectral efficiency when operating on a serving cell.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode. In one example, a gNB may operate in full-duplex (or SBFD) mode on a carrier in band. In one example, a gNB may operate in full-duplex (or SBFD) mode across one or more carriers in a band. In one example, a gNB may operate in full-duplex (or SBFD) mode across one or more carriers in two or more bands.

In one example, a TDD serving cell supports a mix of full-duplex and half-duplex UEs. For example, UE1 supports full-duplex operation and UE2 supports half-duplex operation. The UE1 can transmit and receive simultaneously in a slot or symbol when configured, scheduled, assigned or indicated by the gNB. UE2 can either transmit or receive in a slot or symbol while simultaneous DL reception by UE2 and UL transmission from UE2 cannot occur on the same slot or symbol.

FD transmission/reception is not limited to gNBs, TRPs, or UEs, but can also be used for other types of wireless nodes such as relay or repeater nodes.

Embodiments of the present disclosure recognize that full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout the disclosure, for conciseness of description and illustration purposes, the term SBFD is used as a short form for a full-duplex operation in a wireless system. The terms ‘cross-division-duplex’ (XDD), ‘full duplex’ (FD), ‘subband-full-duplex’ (SBFD), or ‘single frequency full-duplex’ (SFFD), or ‘adaptive Duplex’ or ‘SBFD’ operation in a wireless communication system supporting ‘full duplex’ may correspond to one or a combination of ‘half-duplex’ (or non-simultaneous transmission and reception capability) and/or ‘full duplex’ (or simultaneous transmission and reception capability) by one or more wireless communication devices such as a UE or a gNB/BS/TRP in a wireless communication network. For example, a simultaneous or a (non-)simultaneous transmission and reception capability may be associated with a single carrier operation in a band, or with one or more bandwidth parts or bandwidth segments operation in one or multiple bands, or with a carrier aggregation or dual-connectivity operation in one or multiple bands.

FD operation in NR can improve spectral efficiency, link robustness, capacity, and latency of UL transmissions. In an NR TDD system, transmissions from a UE are limited by fewer available transmission opportunities than receptions by the UE. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any transmission from the UE can only occur in a limited number of UL slots, for example every 2, 2.5, or 5 msec, respectively.

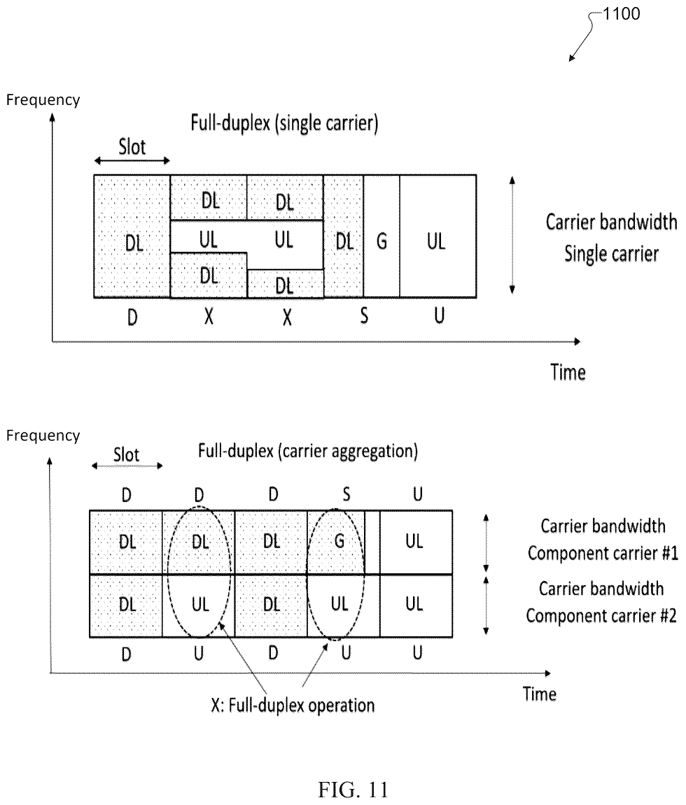

FIG. 11 illustrates timelines 1100 of example FD configurations according to embodiments of the present disclosure. For example, timelines 1100 can be followed by any of the UEs 111-116 and the gNB 102 and/or network 130 in the wireless network 100 of FIG. 1. This example is for illustration only and other embodiments can be used without departing from the scope of the present disclosure.

With reference to FIG. 11, for a single carrier TDD configuration with FD enabled, slots denoted as X are FD slots. Both DL and UL transmissions can be scheduled in FD slots for at least one or more symbols. The term FD slot is used to refer to a slot where UEs can simultaneously receive and transmit in at least one or more symbols of the slot if scheduled or assigned radio resources by the base station. A half-duplex UE cannot transmit and receive simultaneously in a FD slot or on a symbol of a FD slot. When a half-duplex UE is configured for transmission in symbols of a FD slot, another UE can be configured for reception in the symbols of the FD slot. A FD UE can transmit and receive simultaneously in symbols of a FD slot in presence of other UEs with resources for either receptions or transmissions in the symbols of the FD slot. Transmissions by a UE in a first FD slot can use same or different frequency-domain resources than in a second FD slot, wherein the resources can differ in bandwidth, a first RB, or a location of the center carrier.

When a UE receives signals/channels from a gNB in a full-duplex slot, the receptions may be scheduled in a DL subband of the full-duplex slot. When full-duplex operation at the gNB 102 uses DL slots for scheduling transmissions from the UE 116 using full-duplex transmission and reception at the gNB 102, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB 102 uses UL slots for purpose of scheduling transmissions to UEs using full-duplex transmission and reception at the gNB 102, there may be one or multiple, such as two, UL subbands in the full-duplex slot.

For a carrier aggregation TDD configuration with FD enabled, a UE receives in a slot on CC #1 and transmits in at least one or more symbols of the slot on CC #2. In addition to D slots used only for transmissions/receptions by a gNB/UE, U slots used only for receptions/transmissions by the gNB/UE, and S slots that are used for both transmission and receptions by the gNB/UE and also support DL-UL switching, FD slots with both transmissions/receptions by a gNB (e.g., the BS 102) or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation.

Transmissions from a UE can also occur in a last slot (U) where the full UL transmission bandwidth is available. FD slots or symbol assignments over a time period/number of slots can be indicated by a DCI format in a PDCCH reception and can then vary per unit of the time period, or can be indicated by higher layer signaling, such as via a MAC CE or RRC.

Although FIGS. 10-11 illustrates diagrams, various changes may be made to the diagrams 1000-1100 of FIGS. 10-11. For example, while certain diagrams (such as diagrams 1000, 1100) describe a certain slot structure, various components combined, further subdivided, or omitted and additional components can be added according to particular needs.

In the following and throughout the disclosure, various embodiments of the disclosure may be also implemented in any type of UE including, for example, a 6G UE, or a UEs with the same, similar, or more capabilities compared to a Rel-21 6G or a 5G/NR UEs. Although various embodiments of the disclosure discuss 3GPP 6G 5G/NR wireless communication systems, the embodiments may apply in general to UEs operating with other RATs and/or standards, such as next releases/generations of 3GPP, IEEE Wi-Fi, and so on.

The term ‘activation’ describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

In the following, unless otherwise explicitly noted, providing a parameter value by higher layers includes providing the parameter value by a system information block (SIB), such as a SIB1, or by a common RRC signaling, or by UE-specific RRC signaling.

In the following, the suffix ‘-rxx’ is used to denote a parameter that does not currently exist in specifications and can be introduced to support the disclosed functionalities, with ‘xx’ denoting a number of a 3GPP release for the introduction of the parameter, e.g., xx=20 for Rel-20, or xx =21 for Rel-21, etc.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with an SCell or additional secondary cell groups (SCGs) by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an master cell group (MCG) or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in REF3 when using 5G/NR.

Throughout the disclosure, an SSB is used as a short form for a SS/PBCH block. The terms SSB and SS/PBCH block are interchangeably used in this disclosure.

In certain embodiments, a UE may be provided with an SBFD configuration based on a parameter sbfd-config to determine receptions and/or transmissions on a serving cell supporting full-duplex operation. For example, the UE may be provided with a set of RBs or a set of symbols for an SBFD UL or DL subband on a symbol or in a slot based on sbfd-config.

For example, the UE may be provided with a set of symbols or slots for an SBFD subband based on sbfd-config. An SBFD configuration may be provided by higher layers, e.g., RRC, or may be indicated based on DCI and/or MAC-CE signaling. A combination of SBFD configuration based on higher layer parameters such as sbfd-config and indication through DCI and/or MAC-CE signaling may also be used. The UE may determine an SBFD configuration for a symbol or a slot or a set of symbols or a set of slots using higher layer parameters provided for an SBFD configuration and based on reception or transmission conditions such as a slot type ‘D’, ‘U’, or ‘F’ or a slot or a symbol type ‘SBFD’ or ‘non-SBFD’ or for an SBFD subband type such as ‘SBFD DL subband’, ‘SBFD UL subband’, or ‘SBFD Flexible subband’. In one example, the SBFD configuration and/or parameters associated with the SBFD configuration are same for TRPs. In one example, the SBFD configuration and/or parameters associated with the SBFD configuration can be TRP specific following the configuration examples mentioned herein.

For example, an SBFD configuration may provide a set of time-domain resources, e.g., symbols/slots, where receptions or transmissions by the UE are allowed, possible, or disallowed. An SBFD configuration may provide a range or a set of frequency-domain resources, e.g., serving cell, BWP, start and/or end or a set of RBs, where receptions or transmissions by the UE are allowed, possible, or disallowed. An SBFD configuration may provide one or multiple guard intervals or guard RBs for time and/or frequency domain radio resources during receptions or transmissions by the UE, e.g., guard SCs or RBs, guard symbols. An SBFD configuration may be provided based on one or multiple resource types such as ‘non-SBFD symbol’ or ‘SBFD symbol’, or ‘simultaneous Tx-Rx’, ‘Rx only’, ‘Tx only’ or ‘D’, ‘U’, ‘F’, ‘N/A’. An SBFD configuration may be associated with one or multiple scheduling behaviors, e.g., for “dynamic grant”, for “configured grant”, for “any”. An SBFD configuration and/or parameters associated an SBFD configuration may include indications or values to determine Tx power settings of receptions by the UE, such as, reference power, energy per resource element (EPRE), or power offset of a designated channel/or signal type transmitted by a serving gNB, or to determine the power and/or spatial settings for transmissions by the UE.

For example, a UE may be provided with an SBFD configuration to determine receptions and/or transmissions on a serving cell supporting full-duplex operation. For example, the UE may be provided with a set of RBs or a set of symbols for an SBFD UL or DL subband on a symbol or in a slot (frequency domain resources). For example, the UE may be provided with a set of symbols or slots for an SBFD subband (time domain resources). In one example, the SBFD configuration applies to TRPs in the cell. In one example, the SBFD configurations are separately provided for each TRP in the cell. In one example, a common SBFD configuration is provided for a cell, and an additional delta configuration is separately provided for each TRP in the cell, wherein the delta configuration can include additional frequency/time domain resources to be added to the common configuration and/or excluded frequency/time domain resources to be excluded from the common configuration. In one example, the SBFD configurations are separately provided for each TRP in the cell. In one example, a common SBFD configuration is provided for a first TRP of the cell and an additional delta configuration is provided for each other TRP in the cell, wherein the delta configuration can include additional frequency/time domain resources to be added to the common configuration and/or excluded frequency/time domain resources to be excluded from the common configuration.

For example, an SBFD configuration and/or parameters associated with the SBFD configuration may be provided to the UE by means of common RRC signaling using SIB, or be provided by UE-dedicated RRC signaling such as ServingCellConfig. For example, an SBFD configuration and/or parameters associated with the SBFD configuration may be provided to the UE using an RRC-configured time domain resource assignment (TDRA) table, or a PDCCH, PDSCH, PUCCH or PUSCH configuration, and/or DCI-based signaling that can indicate to the UE a configuration or allow the UE to determine an SBFD configuration on a symbol or slot.

For example, the UE may be provided with information for an SBFD subband configuration such as an SBFD UL subband in one or more SBFD symbols by higher layer signaling. For example, a frequency-domain location and a size or a frequency-domain occupancy of the SBFD subband may be provided to the UE by means of indicating or assigning a start RB and an allocation bandwidth, or based on a resource indicator value (RIV), or a number of RBs, or a bitmap. An SBFD subband configuration may be provided to the UE with respect to a common resource block (CRB) grid. An SBFD subband configuration may be provided to the UE with respect to a UE BWP configuration, e.g., excluding resource blocks (RBs) in an NR carrier BW that are not within a configured or an active UE BWP. An SBFD subband configuration may be provided based on a reference RB and/or based on a reference SCS. The UE may be provided with information for an SBFD subband configuration such as an SBFD DL subband in an SBFD slot or symbol by higher layer signaling. For example, a frequency-domain location and a size or a frequency-domain occupancy of an SBFD DL subband may be provided to the UE by means of indicating or assigning a start RB and an allocation bandwidth, or an RIV value, or a number of RBs, or a bitmap, separately from a configuration provided to the UE for an SBFD UL subband. An SBFD DL subband configuration may be provided to the UE with respect to a CRB grid, or with respect to a UE BWP configuration. An SBFD DL subband configuration may be provided based on an indicated reference RB and/or based on a reference SCS. There may be multiple SBFD DL subband configurations in an SBFD symbol or slot. If multiple SBFD DL subband configurations are provided for an SBFD symbol or slot, the SBFD DL subbands may be non-contiguous. For example, two SBFD DL subband configurations may be provided to the UE for an SBFD symbol by higher layers. A same SBFD DL subband configuration or a same SBFD UL subband configuration may be provided for multiple symbols or slots, or different symbols or slots may be indicated or assigned separate SBFD DL subband and/or SBFD UL subband configurations, respectively.

For example, an SBFD configuration and/or parameters associated with the SBFD configuration for sbfd-config may be provided to the UE using tdd-UL-DL-ConfigurationCommon as example for RRC common configuration and/or tdd-UL-DL-ConfigurationDedicated as example for UE-specific configuration. The UE may determine an SBFD configuration based on a common TDD UL-DL frame configuration of a serving cell by receiving a SIB such as a SIB1 when accessing the cell from RRC_IDLE/INACTIVE or by RRC signaling when the UE is configured with an SCell or additional SCGs by an IE ServingCellConfigCommon in RRC_CONNECTED. The UE may determine an SBFD configuration based on a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration can designate a slot or symbol as one of types ‘D’, ‘U’ or ‘F’ using at least one time-domain pattern with configurable periodicity.

Using the Rel-19 NR Duplex feature, for example, the UE (e.g., the UE 116) may be provided with a set of symbols or slots for an SBFD subband based on sbfd-config. For example, a DL or flexible symbol provided by parameter tdd-UL-DL-ConfigurationCommon can include an UL sub-band provided by ulSubbandlocationAndBandwidth, a first DL sub-band may be provided by firstdlSubbandlocationAndBandwidth and may additionally include a second DL sub-band provided by seconddlSubbandlocationAndBandwidth, for a SCS configuration μof any configured UL BWP or DL BWP, respectively, as provided by parameter scs-SpecificCarrierList. The downlink or flexible symbol can then be referred to as an SBFD symbol; or otherwise as a non-SBFD symbol. For example, SBFD symbols may be provided in consecutive order, starting from a first slot provided by parameter SBFD-StartingSlotIndex and from a first symbol in the first slot provided by SBFD-StartingSymbolInd, and end in a second slot provided by SBFD-EndingSlotIndex and in a second symbol in the second slot provided by SBFD-EndingSymbolIndex. SBFD symbols may be provided in any of pattern1 and, if provided, pattern2 of tdd-UL-DL-ConfigurationCommon. A configuration period for SBFD symbols may correspond to P msec when only pattern1 is provided, or P+P₂ when pattern2 is additionally provided.

In certain embodiments, a TCI state may be used for beam indication. A TCI state may refer to a DL TCI state for DL channels, e.g. PDCCH or PDSCH, an UL TCI state for UL channels, e.g. PUSCH or PUCCH, a joint TCI state for DL and UL channels, or separate TCI states for UL and DL channels or signals. A TCI state may be common across multiple component carriers or may be a separate TCI state for a component carrier of a set of component carriers. A TCI state may be gNB or UE panel specific or common across panels. In some examples, an UL TCI state may be replaced by an SRS resource indicator (SRI).

Terminology such as TCI, TCI states, SpatialRelationInfo, target RS, reference RS, and other terms is used for illustrative purposes and is therefore not normative. Other terms that refer to same functions can also be used. A “reference RS” corresponds to a set of characteristics of a DL RX beam or an UL TX beam, such as a direction, a precoding/beamforming, a number of ports, and so on. A beam may also be referred to as spatial filter or spatial setting and be associated with a TCI state for quasi co-location (QCL) properties.

In certain embodiments, a cell may include more than one transmission/reception point (TRP). For example, mTRP operation may be referred to as intra-cell mTRP operation. In one example, a TRP may be identified by a CORESETPoolIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) channel state information reference signal (CSI-RS) resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on. In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples. In one example, a TRP may be identified by a group (e.g., one or more) sounding reference signal (SRS) resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on.

In certain embodiments, the term “FR1” or a frequency range designation “FR1” may refer to a corresponding frequency range 410-7125 MHz; the term “FR2-1” or a frequency range designation “FR2-1” may refer to a corresponding frequency range 24250-52600 MHz; the term “FR2-2” or a frequency range designation “FR2-2” may refer to a corresponding frequency range 52600-71000 MHz; the term “FR2”or a frequency-range designation “FR2”may refer to FR2-1 or FR2-2.

In certain embodiments, the term “FR3” or a frequency range designation “FR3” may refer to a corresponding frequency range 7125-24250 MHz, or parts thereof. For example, an FR3 band may correspond to 7125-8400 MHz, or parts thereof, in ITU Region 2 or ITU Region 3. For example, an FR3 band may correspond to 7125-7250 MHz or 7750-8400 MHz, or parts thereof, in ITU Region 1. For example, an FR3 band may correspond to 14800-15350 MHz, or parts thereof, in an ITU Region. For example, for simplicity and illustration purposes, the term “FR3 7-8 GHz” may be used to refer to 6G radio access on a carrier or in a band of a frequency range such as 7125-8400 MHz, or the term “FR3 14-15 GHz” may be used to refer to 6G radio access on a carrier or in a band of a frequency range such as 14800-15350 MHz. The term “FR3 7-8 GHz” may be used interchangeably with a term such as “FR3 band 7-8 GHz”or “6G band 7-8 GHz”.

In certain embodiments, 6G radio access may be supported on a carrier or in a band of a frequency range such as FR1 corresponding to 4400-4800 MHz, or in a carrier or in a band corresponding to an FR1 or an FR2 operating band as defined in REF7. For example, the term “FR1 4 GHz”may be used interchangeably with a term such as “FR1 band 4 GHz”or “6G band 4 GHz”.

In certain embodiments, 5G/NR or 4G/LTE radio access may be supported on a carrier or in a band of a frequency range corresponding to an FR1 operating band, or 5G/NR radio access may be supported on a carrier or in a band of an FR2 operating band such as defined in REF7 for 5G/NR.

In certain embodiments, a UE supporting 6G radio access may operate in single RAT mode or may operate in dual RAT mode.

For example, when operating in single RAT mode, the UE may select one RAT, e.g., one of 4G/LTE or 5G/NR or 6G radio access to (re-)select and camp on a serving cell in a band when in RRC_IDLE or RRC_INACTIVE state. For example, when operating in single RAT mode, the UE may be indicted one or more serving cells corresponding to one RAT in one or more bands by the network using mobility or handover procedures when in RRC_CONNECTED state. For example, a UE supporting 6G radio access and operating in single RAT mode may also support 4G/LTE or 5G/NR radio access or may also support other wireless radio access such as Wi-Fi or Bluetooth or UWB.

For example, a dual RAT mode may be based on carrier aggregation operation, or dual connectivity operation or dual active protocol stack operation. For example, when operating in dual RAT mode, a multiple Rx and/or multiple Tx capable UE may be concurrently or simultaneously active on two serving cells using a separate RAT for each serving cell, respectively, wherein a first RAT may correspond to 6G radio access, and a second RAT corresponds to one of 5G/NR radio access or 4G/LTE radio access. For example, when operating in dual RAT mode, the UE may be indicated with a first cell group comprising one or more serving cells corresponding to the first RAT, and a second cell group comprising one or more serving cells corresponding to the second RAT. For example, the first cell group may correspond to an MCG and the second cell group may correspond to an SCG with reference to carrier aggregation or dual connectivity. Serving cells or cell groups may be located in a same or in different bands. For example, a UE supporting 6G radio access and operating in dual RAT mode may also support 4G/LTE or 5G/NR radio access or may also support other wireless radio access.

For example, when operating in dual RAT mode based on principles such as described in REF11 for multi-RAT dual-connectivity operation for scenarios such as LTE-NR or NR-LTE or NR-NR, a UE supporting 6G radio access may be configured to utilize radio resources provided by two different nodes connected via non-ideal or ideal backhaul, one node providing 6G radio access and the other node providing either 4G/LTE or 5G/NR radio access. One node may act as a master node (MN) and the other as secondary node (SN), where the MN and SN are connected via a network interface and at least the MN is connected to the core network. Transmissions to the UE or receptions from the UE using 4G/LTE or 5G/NR radio access may then occur on a primary cell group (PCG), and transmissions to the UE or receptions from the UE using 6G radio access may then occur on a secondary cell group (SCG). In another example, 6G radio access may occur on the PCG and 4G/LTE or 5G/NR radio access may occur on the SCG. For example, when operating in dual RAT mode based on carrier aggregation, if supported by 6G radio access, the UE supporting 6G radio access may be scheduled per cell group and network-side scheduling between the first and the second cell group, respectively, may or may not be coordinated between the cell groups.

For example, when operating in dual RAT mode based on dual active protocol stack operation, the UE supporting 6G radio access may be connected to a 6G serving cell in a first band while being connected to a 4G/LTE or 5G/NR cell in a second band. In one example, a dual-active protocol stack UE maintains separate RRC states with respect to the radio access network, i.e., a first RRC state corresponding to the 6G radio access and a second RRC state corresponding to the 5G/NR or the 4G/LTE radio access. In one example, a dual-active protocol stack UE may maintain a same or separate mobility or connection states with respect to the core network, i.e., a first mobility or connection management state corresponding to the 6G radio access and a second mobility or connection state corresponding to the 5G/NR or the 4G/LTE radio access.

In certain embodiments, a UE supporting 6G radio access may transmit or receive on a carrier or in a band of a band combination according to carrier aggregation operation, or according to dual connectivity operation, or according to dual active protocol stack operation. Without loss of generality and for conciseness of description, the term “band combination” may refer to a band combination such as defined with respect to a carrier-aggregation band combination, or such as a dual connectivity band combination, or such as a dual active protocol stack band combination. For example, a UE supporting 6G radio access may operate in FDD mode or in TDD mode on a carrier or in a band. For example, the UE supporting 6G radio access may operate in a combination of FDD and/or TDD modes in a band or in a band combination.

In certain embodiments, the UE supporting 6G radio access may transmit or receive on a carrier or in a band of a band combination according to carrier aggregation operation, or according to dual connectivity operation, or according to dual active protocol stack operation using a single UL carrier or using two or more UL contiguous or non-contiguous carriers. For example, based on single UL carrier operation, the UE supporting 6G radio access may transmit an UL signal or channel in a first UL carrier corresponding to 6G radio access or may transmit an UL signal or channel in a second UL carrier corresponding to 5G/NR radio access but the UL transmissions on the first and the second UL carrier then may occur separately in time-domain, e.g., in different slots or symbols, respectively, and the UE may switch between UL transmissions in the first and the second UL carrier, respectively. For example, the UE supporting 6G radio access may be capable of simultaneous UL transmission in two or more UL carriers in a same band or in different bands of a band combination. For example, a UE supporting 6G radio access using a single carrier or using two or more UL carriers may support a switching or a simultaneous UL transmission capability with respect to some or all UL signals or channel types. For example, the UE may support switching with respect to an UL signal of type SRS. For example, the UE may support simultaneous UL transmission capability with respect to an UL channel of type PUSCH on two or more UL carriers.

To address some of the disadvantages for time-division duplex (TDD) or full-duplex (FD) operation, inter-gNB cross-link interference (CLI) estimation and equalization by an gNB advanced receiver can be applied. There are several options for operating a gNB (e.g., the BS 102) receiver.

For example, a UL receiver design expectation at the gNB is that the gNB-to-gNB interference covariance matrix can't be estimated and is not used as input for the gNB receiver. For example, this type of receiver can be denoted as LMMSE-IRC and can more generally be regarded as baseline. Several variations of an LMMSE-IRC based receiver design exist.

For example, the gNB receiver capabilities can be further improved. In one example, it can be expected that a victim gNB, i.e., a gNB which is subjected to CLI from another gNB, is able to estimate the gNB-to-gNB interference covariance matrix based on an UL DMRS. For example, to obtain such an estimation, it may be expected that the victim gNB uses a clean channel estimation based on an UL DMRS and subtracts a channel estimation of an UL DMRS contaminated with an inter-gNB CLI contribution from an aggressor gNB, i.e., another gNB which may transmit a DL signal potentially affecting the UL receiver performance of the victim gNB. For example, a corresponding interference contribution may then be approximated as a Wishart distribution. For example, this type of receiver can be denoted as a Wishart e-LMMSE-IRC.

For example, the gNB can estimate the gNB-to-gNB interference covariance matrix. The victim gNB can use signals or channels such as an SSB or a NZP CSI-RS transmitted by a potential aggressor gNB for a gNB-to-gNB CLI estimation. Note that actual knowledge or an exchange of scheduling information between gNBs, e.g., a PDSCH or a PDCCH is present or absent on the time-/frequency radio resources may or may not be necessary. For example, the configured time-/frequency locations of the SSB or NZP CSI-RS measurement signals may be indicated from a first gNB to a second gNB. For example, resource muting, i.e., empty or unoccupied REs or RBs as part of an UL transmission from the UE to the victim gNB or as part of a DL transmission by the aggressor gNB may be employed to aid a CLI estimation by the victim gNB. Based on the CLI estimation, the victim gNB UL receiver may then equalize a received UL transmission with respect to an inter-gNB CLI contribution in a slot or symbol.

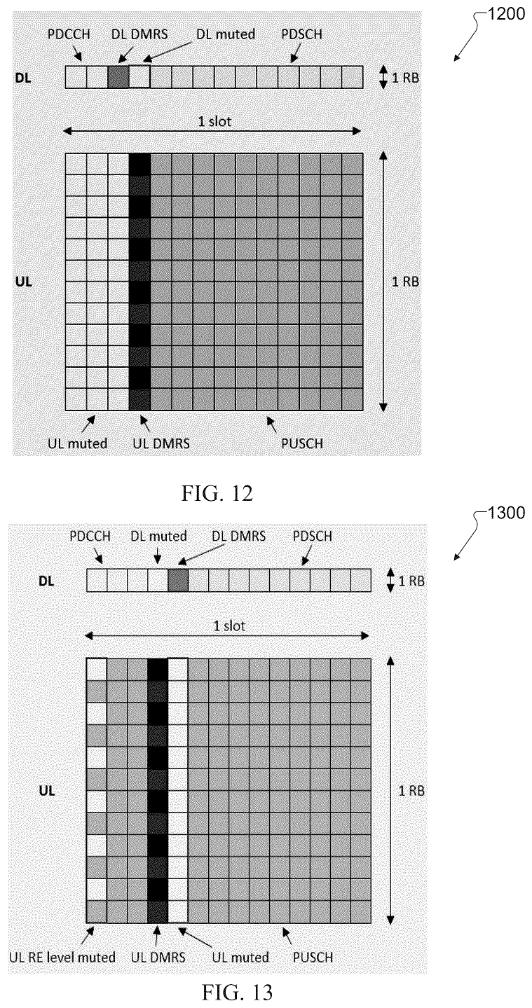

FIG. 12 illustrates an example transparent resource muting pattern 1200 according to embodiments of the present disclosure. For example, transparent resource muting pattern 1200 can be utilized by any of the UEs 111-116 and the gNB 102 and/or network 130 in the wireless network 100 of FIG. 1. This example is for illustration only and other embodiments can be used without departing from the scope of the present disclosure.

For example, when a resource muting is done with RB or symbol level resolution, i.e., an RB or a symbol or multiples thereof is muted and not used for transmission, a victim gNB may allocate such radio resources to the UE (e.g., the UE 116) through scheduling. For example, this type of resource muting can be said to UE transparent when no change to existing NR signal or channel structure is necessary. In another example, when a resource muting is done with RE level resolution, e.g., a RE or more are muted within a PUSCH symbol, this type of resource muting can be said to be UE non-transparent when a change to existing NR signal or channel structure is necessary. For example, RE level muting may be UE transparent with respect to existing NR signal structure or channel when taking into account that a PUSCH DMRS symbol may result in unused REs on the symbol in the PUSCH allocation in cases such as when CDM groups without data are indicated or configured to the UE. For example, to estimate an interfering signal with respect to one or multiple aggressor gNBs, one or multiple resource muting patterns may be used.

With reference to FIG. 12, an example timeline is shown for a transparent UL resource muting pattern for the gNB to measure or estimate a covariance matrix of inter-site gNB-gNB co-channel inter-subband CLI. In the example, a PDCCH is scheduled in the first 2 symbols in a slot within an SBFD DL subband and a PDSCH is scheduled in the other symbols of the slot. A DL DMRS is allocated to the 3^{rd} symbol in the slot assuming PDSCH mapping Type B. In the SBFD UL subband, a PUSCH is scheduled from the 4^{th} symbol in the slot, and one UL DMRS is allocated on the 4^{th} symbol for PUSCH mapping Type B. For example, to avoid the effect of co-channel inter-subband CLI on a UL DMRS based channel measurement, the 4^{th} symbol within the SBFD DL subband is muted by a DL RB-level rate matching resource. In the example, there are 3 UL muting symbols and 1 DL muting symbol in this pattern.

FIG. 13 illustrates an example non-transparent resource muting pattern 1300 according to embodiments of the present disclosure. For example, non-transparent resource muting pattern 1300 can be utilized by any of the UEs 111-116 and the gNB 103 and/or network 130 in the wireless network 100 of FIG. 1. This example is for illustration only and other embodiments can be used without departing from the scope of the present disclosure.

With reference to FIG. 13, an example timeline is shown for a non-transparent UL resource muting pattern for the gNB to measure or estimate a covariance matrix of inter-site gNB-gNB co-channel inter-subband CLI. In the example, a PDCCH is scheduled in the first 3 symbols in a slot within an SBFD DL subband and a PDSCH is scheduled starting from the 5^{th} symbols of the slot. A DL DMRS is allocated to the 5^{th} symbol in the slot assuming PDSCH mapping Type B. In the SBFD UL subband, a PUSCH with mapping type A is scheduled from the 1^{st} symbol in the slot, and one UL DMRS is allocated on the 4^{th} symbol. The 1^{st} PUSCH symbol is muted using a comb-2 muting pattern. For example, a 3 dB UL power boosting may be applied to the non-empty, e.g., not muted REs carrying data and/or control in the 1^{st} symbol to compensate for the loss from the comb-2 RE muting. The 5^{th} PUSCH symbol is fully muted, e.g., to avoid the effect of co-channel inter-subband CLI with respect to the DL DMRS. In the example, are 1.5 UL muting symbols and 1 DL muting symbol in this pattern.

When taking into account UE procedures for transmitting the physical uplink shared channel (PUSCH) in a time-division duplex (TDD) or full-duplex (FD) system where an advanced receiver may be used, several issues related to limitations and drawbacks of existing technology need to be overcome in order to enable system operation according to channel conditions or to reduce UE and/or gNB modem complexity.

It needs to be taken into account that if non-transparent UL resource muting is supported, e.g., for an interference covariance matrix measurement by the gNB or for a gNB-to-gNB CLI measurement, a resulting change and impact to the UE and gNB modem complexity may be high. A reduced availability or a smaller or an unequal number of REs on symbols of a channel or signal such as PUSCH for a same allocation bandwidth and a same number of symbols when UE non-transparent resource muting is employed can adversely impact the UE and/or gNB implementation cost and/or the transmitter or receiver performances.

In one example, when UL resource muting is applied, a number of bits available for TB processing may need to be adjusted accordingly. For example, a PUSCH resource mapping may need to be adjusted such as rate-matching around muted REs. For example, a TB size determination may need to account for presence of muted REs, or mapping for UCI resources may need to be changed. A resulting modem complexity may then be increased correspondingly.

In another example, when UL resource muting is applied, different symbols of a PUSCH allocation may carry a different number of data-carrying REs and/or muted REs, respectively, which can increase a complexity for the TB and L1 processing chain implementation in the modem or affect the transmitted signal quality or affect the received signal demodulation performance. For example, a transmitter side EVM performance may be reduced or a larger maximum power reduction (MPR) value may be needed by the UE for a PUSCH transmission in a given allocation bandwidth and frequency location in the carrier to meet a certain desired signal quality level. Accordingly, a supported operating signal-to-interference-plus-noise ratio (SINR) or UL link budget can be reduced when additional or adjusted filtering become needed.

In another example, when UL resource muting is applied and muted REs are present on a symbol of the PUSCH, an impact to phase continuity across symbols may result. For PUSCH transmissions across symbols, it may be desired to preserve power level a phase coherency across the comb-2 muted and not muted PUSCH symbols to preserve an equal total power per PUSCH symbol. Therefore, the corresponding Tx EPRE for some DMRS symbols may need to be adjusted with respect to other PUSCH data symbols. Accordingly, a more complex UE or gNB modem implementation may be needed to adjust or preserve a transmission power with respect to RE level and symbol level EPRE values.

Therefore, embodiments of the present disclosure recognizes that there is a need for methods and procedures to support non-transparent UL resource muting for UL transmissions in order to enable gains with advanced receivers such as based on the principle of CLI estimation and equalization while allowing for reduced UE and/or gNB modem complexity with flexibility to adjust for system operating conditions.

In certain embodiments, a comb-N, e.g., N=2, N=4 or N=8, muted data symbol of a PUSCH may refer to a data symbol where every N^{th} resource element (RE) in an RB or every N^{th} RE with respect to a suitably chosen frequency domain reference unit is not used to convey channel coded and/or modulated data or control.

In one example, a comb-2 muted data symbol in an RB may use every other subcarrier (SC) to transmit data. The remaining sub-carriers may correspond to zero-power REs on which no transmission occurs. A half of the REs in the RB is then used by the UE to transmit data or control in the RB and another half of the REs in the RB is not used by the UE to transmit. In another example, a comb-4 muted data symbol may refer to muting every 4^{th} SC in an RB and 3 out of 4 SCs in the RB are used by the UE to transmit data or control.

The examples are chosen for illustration purposes and without loss of generality can be generalized to partially muted data symbols including other example cases such as when an irregular comb-N structure is used or employed for muting in an RB or with respect to a suitably chosen frequency domain reference unit. In one example, in a partially muted data symbol a first subset of M1 subcarriers in the symbol in an RB may be used by the UE to transmit data or control on corresponding REs and a second subset of M2 subcarriers in the symbol in the RB is muted, e.g., the UE doesn't transmit on the second subset of M2 SCs. Here, L=M1+M2 may be suitably selected with respect to a frequency domain reference unit, e.g., L=12 SCs per RB. In the example, M1 may correspond to a first subset of subcarrier indices, e.g., {1, 3, 4, 5, 9, 10} and M2 may correspond to a second subset of subcarrier indices, e.g., {0, 2, 6, 7, 8, 11}. In the example, a half of the subcarriers in the RB are muted but not using a regular comb-2 structure.

In certain embodiments, a comb-N, e.g., N=2, 4 or 8, muted DMRS symbol may refer to an DMRS symbol of a PUSCH where every N^{th} RE in an RB or every N^{th} RE with respect to a suitably chosen frequency domain reference unit is not used to transmit a demodulation reference or pilot signal.

In one example, a comb-2 muted DMRS symbol in an RB may use every other subcarrier (SC) to transmit the demodulation reference or pilot signal. The remaining sub-carriers may correspond to zero-power REs on which the UE does not transmit a demodulation reference or pilot signal.

The example is chosen for illustration purposes and without loss of generality can be generalized to partially muted DMRS symbols including other example cases such as when an irregular comb-N structure is used or employed for muting in an RB or with respect to a suitably chosen frequency domain reference unit. In one example, in a partially muted DMRS symbol a first subset of M1 subcarriers in the symbol in an RB may be used by the UE to transmit a reference or pilot signal on corresponding REs and a second subset of M2 subcarriers in the symbol in the RB is muted, e.g., the UE doesn't transmit a reference or pilot signal on the second subset of M2 SCs. Here, L=M1+M2 may be suitably selected with respect to a frequency domain reference unit, e.g., L=12 SCs per RB. In the example, M1 may correspond to a first subset of subcarrier indices, e.g., {0, 1, 4, 5, 8, 9} and M2 may correspond to a second subset of subcarrier indices, e.g., {2, 3, 6, 7, 10, 11}. In the example, a half of the subcarriers in the RB are muted but a regular comb-2 structure is not used.

For example, a comb-N muted DMRS symbol or a partially muted DMRS symbol may correspond to a DMRS type provided by Rel-15 NR specifications. For example, one or more subsets of muted REs in such a symbol may then correspond to one or more CDM groups without data.

In certain embodiments, a comb-N muted data symbol or a comb-N muted DMRS symbol, or a partially muted data symbol or a partially muted DMRS symbol may be used for transmission of an UL signal or channel by the UE. For example, an UL transmission by the UE may correspond to a PUSCH using OFDM or DFTS-OFDM modulation.

Throughout the disclosure, the term ‘UL muting” is used as a short form for “not transmitting on a set of REs in a set of RBs on one or more symbols of a PUSCH transmission wherein the PUSCH allocation in time-and/or frequency domain is otherwise mostly expected to be contiguous in absence of UL muting”. With reference to Rel-15 NR and in frequency-domain, for example PUSCH resource allocation type 0 can be used. A contiguous block of RBs may be allocated to the UE using a Resource Indication Value (RIV) associated with a starting RB and a number of contiguous RBs for the PUSCH allocation. “Mostly contiguous” then can mean that with few exceptions such as REs corresponding to CDM groups without data on a DMRS symbol, the REs over the PUSCH allocation bandwidth would be used to transmit data or control or reference/pilot signals in absence of UL muting. In another example, using PUSCH resource allocation type 1, resources may be assigned in groups of RBs called RBGs, and a bitmap may be used to indicate which RBGs the UE should use for the PUSCH transmission. “Mostly contiguous” then can mean, per contiguous segments or per cluster of the PUSCH allocation. Similar implementations can be extended to time-domain. With reference to Rel-15 and in time-domain, a number of contiguous symbols corresponding to a PUSCH allocation in a slot may be indicated to the UE based on a time-domain resource allocation (TDRA) table and/or TDRA field in a DCI. “Mostly contiguous” then may refer to a number of consecutive symbols in the PUSCH allocation. The terms ‘UL muting’, “UL resource muting” and ‘comb-N muting’ may be used interchangeably in the disclosure.

In certain embodiments, the term “UL muting pattern” is used as short form for a set of muted REs in a set of RBs on one or more symbols of PUSCH allocation”. A UE may be provided with a configuration of UL muting or an UL muting pattern for a PUSCH based on a higher layer parameter ulMutingConfig. For example, a parameter ulMutingConfig may correspond to pusch-MutingResources provided by PUSCH-Config for a dynamic grant PUSCH or a Type 2 configured grant PUSCH or provided by configuredGrantConfig for a Type 1 configured grant PUSCH. For example, the UE may be provided with a parameter such as a value for N, e.g., N=2, or a value for a comb offset M on a symbol with respect to a subcarrier index 0, or a set of L symbols associated with the symbols of a PUSCH time-domain allocation on which a comb-N muting pattern may be applied. For example, multiple values or multiple sets for parameter ulMutingConfig may be provided to the UE.

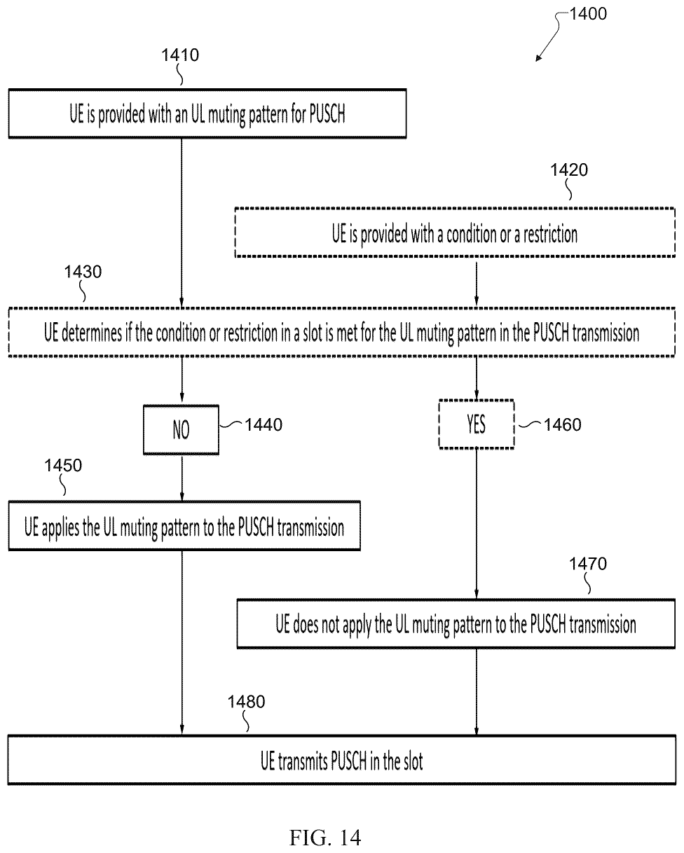

FIG. 14 illustrates a flowchart of an example UE procedure 1400 transmitting PUSCH according to embodiments of the present disclosure. For example, procedure 1400 can be performed by any of the UEs 111-116 of FIG. 1, such as the UE 116. This example is for illustration only and other embodiments can be used without departing from the scope of the present disclosure.

The procedure begins in 1410, a UE is provided with an UL muting pattern for PUSCH. In 1420, the UE may be provided with a condition or a restriction. In 1430, the UE may determine whether the condition or restriction in a slot is met for the UL muting pattern in the PUSCH transmission. In 1440, when the UE determines the condition or restriction in a slot is not met for the UL muting pattern in the PUSCH transmission, then in 1450, the UE applies the UL muting pattern to the PUSCH transmission. In 1460, when the UE may determine the condition or restriction in a slot is met for the UL muting pattern in the PUSCH transmission, then in 1470, the UE does not apply the UL muting pattern to the PUSCH transmission. In 1480, the UE transmits PUSCH in the slot.

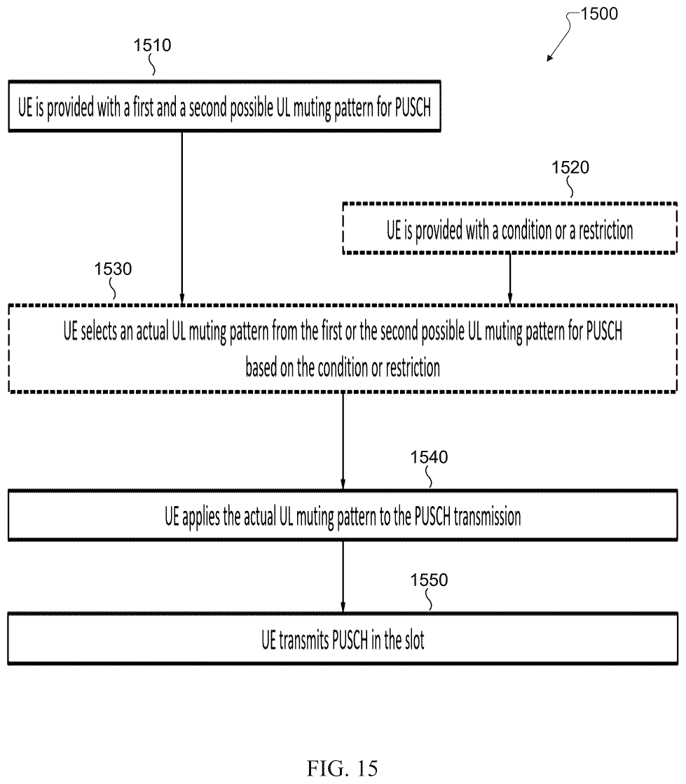

FIG. 15 illustrates a flowchart of an example UE procedure 1500 for transmitting PUSCH according to embodiments of the present disclosure. For example, procedure 1500 can be performed by any of the UEs 111-116 of FIG. 1, such as the UE 111. This example is for illustration only and other embodiments can be used without departing from the scope of the present disclosure.

The procedure begins in 1510, a UE is provided with a first and a second possible UL muting pattern for PUSCH. In 1520, the UE may be provided with a condition or a restriction. In 1530, the UE may select an actual UL muting pattern from the first or the second possible UL muting pattern for PUSCH based on the condition or restriction. In 1540, the UE applies the actual UL muting pattern to the PUSCH transmission. In 1550, the UE transmits PUSCH in the slot.

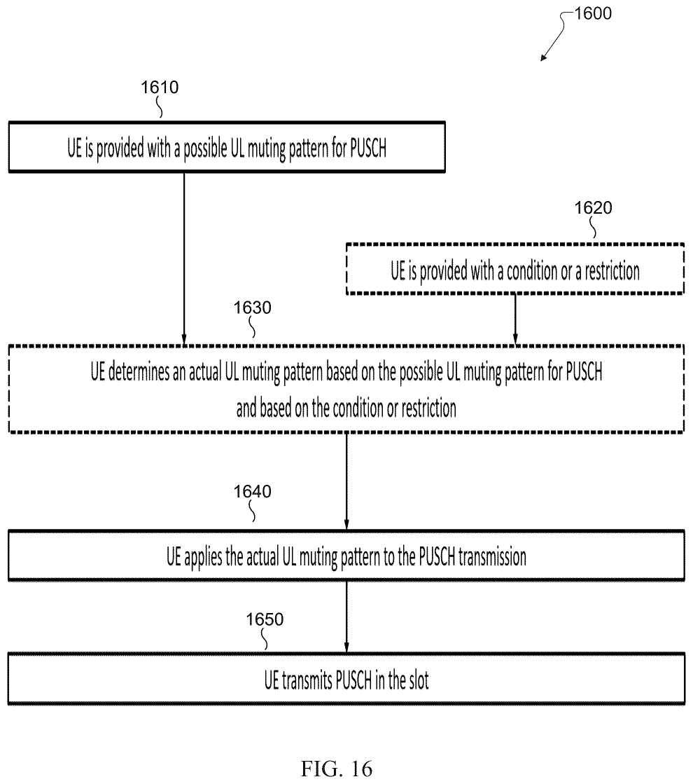

FIG. 16 illustrates a flowchart of an example UE procedure 1600 for transmitting PUSCH according to embodiments of the present disclosure. For example, procedure 1600 can be performed by the UE 116 of FIG. 3. This example is for illustration only and other embodiments can be used without departing from the scope of the present disclosure.

The procedure begins in 1610, a UE is provided with a possible UL muting pattern for PUSCH. In 1620, the UE may be provided with a condition or a restriction. In 1630, the UE may determine an actual UL muting pattern based on the possible UL muting pattern for PUSCH. In 1640, the UE applies the actual UL muting pattern to the PUSCH transmission. In 1650, the UE transmits PUSCH in the slot.

In one embodiment, the UE is provided with a condition or a restriction based on which UL muting for PUSCH is to be applied and when not to applied by the UE.

In a variant, the UE selects an actual UL muting pattern from a set of possible UL muting patterns for a PUSCH transmission based on a condition or a restriction.

In a variant, the UE determines an actual UL muting pattern for a PUSCH transmission based on a possible UL muting pattern based on a condition or a restriction.

For example, a condition or a restriction associated with UL muting may be provided, configured or indicated to the UE based on one of or a combination of DCI-based signaling, L1 control signaling, RRC signaling, or MAC CE based signaling.

For example, a configuration may be provided to the UE by higher layers with parameters associated with a condition or restriction associated with UL muting, e.g., a condition or a restriction subject to which the UL muting in a PUSCH transmission may be applied or not applied. For example, a DCI-based indication may be used by the UE to determine if a condition or a restriction associated with UL muting for PUSCH may be applied or not. For example, a condition or restriction associated with UL muting may be tabulated and/or listed by system operating specifications. A configuration for UL muting on PUSCH may be provided by higher layers to the UE and used in conjunction with DCI-based indication by the UE to determine an UL muting pattern for PUSCH. If a same condition or restriction associated with UL muting is provided for multiple UEs, a common DCI or common RRC signaling message may be used. A UE-specific DCI or RRC signaling of dedicated or common type may be used to provide a condition or a restriction associated with UL muting to a UE. A value or a set of values corresponding to a condition or a restriction may be associated with a parameter for UL muting on a PUSCH. For example, a UE may select or determine a value from the set of values associated with a condition or a restriction for UL muting based on an index value indicated through a DCI format or through MAC-CE signaling wherein the UE selects from one or more entries provided in an RRC configurable table associated with an index value. The UE may determine a default condition or restriction associated with UL muting for a PUSCH.

In one embodiment, a condition or restriction associated with UL muting for PUSCH is provided to the UE using higher layer signaling. For example, a UE (e.g., the UE 116) may be provided with a configuration of UL muting or an UL muting pattern for a PUSCH based on a parameter ulMutingConfig including the condition or the restriction.

For example, a PUSCH configuration in a higher layer parameter ServingCellConfig or PUSCH-Config may be provided to the UE by higher layers and include a parameter associated with UL muting to indicate a set of symbols of a PUSCH allocation on which to apply UL muting and/or a parameter associated with a condition or restriction for the UL muting in a PUSCH allocation. For example, a parameter ulMutingIndicator in PUSCH-Config can indicate to the UE that UL muting is applied or not applied as condition or restriction to the corresponding PUSCH transmission in one or more symbol(s) configured as UL muting resource.

For example, a PUSCH time-domain resource allocation (TDRA) table may be configured for the UE by higher layers and include a parameter associated with UL muting to indicate a set of symbols of a PUSCH allocation on which to apply UL muting. For example, a parameter ulMutingIndicator in a PUSCH allocation of PUSCH-config can indicate to the UE that UL muting is applied or not applied as condition or restriction to the corresponding PUSCH transmission in one or more symbol(s) configured as UL muting resource.

In one embodiment, the PUSCH time-domain resource allocation table may be configured for the UE by higher layers and include a parameter associated with a condition or restriction associated with UL muting for a PUSCH allocation, e.g., for a row of the PUSCH TDRA table or as a parameter provided in the configuration for the PUSCH TDRA table.

For example, the UE may be indicated an entry of a PUSCH time-domain resource allocation table associated with a set of muting symbols in a PUSCH and associated with a condition or a restriction corresponding to the UL muting using a TDRA field in a DCI format. For example, a PUSCH transmission based on a TDRA table for a configured grant may provide a condition or restriction associated with UL muting for PUSCH to the UE. For example, when the UE receives an UL grant DCI format such as a DCI format 0_0, 0_1, 0_2, or 0_3, or when the UE receives a DCI associated with an activation of a configured UL grant, the UE determines a value of the TDRA field in the received DCI, and based on a parameter such as ulMutingIndicator as condition or restriction associated with the value of the TDRA field, the UE can further determine whether UL muting is applied or not applied for a corresponding PUSCH transmission in one or more symbol(s) configured as UL muting resource.

In one embodiment, information may be provided to the UE by higher layers to associate a DL or UL reference signal or a DL or an UL or joint TCI state(s) or RS resource index(es) such as corresponding to an SSB or to a CSI-RS resource index with a condition or restriction for UL muting on PUSCH. For example, a first TCI state may correspond to a PUSCH transmission for which UL muting can be applied by the UE or for which UL muting is allowed or supported, and a second TCI state may correspond to a PUSCH transmission for which UL muting should not be applied by the UE or for which UL muting is not allowed or not supported.

In one embodiment, the UE determines the presence or absence of UL muting for a scheduled or configured PUSCH transmission in a slot based on a provided UL muting pattern and based on a provided condition or restriction. When the condition is met or the restriction is not valid, the UE applies the UL muting pattern to one or more REs of one or more indicated symbols of the PUSCH transmission in the slot, else the UE does not apply the UL muting pattern to the PUSCH and transmits the PUSCH in the slot, or the UE may drop or defer the PUSCH transmission in the slot.

In a variant, the UE selects an actual UL muting pattern for a scheduled or configured PUSCH transmission in a slot based on a set of provided possible UL muting patterns and based on a condition or restriction. When the condition is met or the restriction is not valid, the UE selects an actual UL muting pattern from the set of possible UL muting patterns and applies the selected UL muting pattern as the actual UL muting pattern to one or more REs of one or more indicated symbols of the PUSCH transmission in the slot, else the UE does not apply an UL muting pattern to the PUSCH and transmits the PUSCH in the slot, or the UE may drop or defer the PUSCH transmission in the slot. When more than one possible UL muting patterns for the PUSCH meet the condition or are not precluded by the restriction, a suitably selected rule can be applied to select one of the qualifying possible UL muting patterns as an actual UL muting pattern for the PUSCH transmission. For example, a first indexed or configured possible UL muting pattern may then be further selected, or a priority level may be applied to select an UL muting pattern, or an UL muting pattern resulting in a smallest or a largest number of occupied symbols by the UL resource muting may be selected.

In a variant, the UE determines an actual UL muting pattern for a scheduled or configured PUSCH transmission in a slot based on a provided possible UL muting pattern and based on a condition or restriction. When the condition is met or the restriction is not valid, the UE determines the actual UL muting pattern based on parameters associated with the provided possible UL muting pattern and using the condition or the restriction. The UE adjusts one or more parameters of the possible UL muting pattern according to the condition or restriction to determine the actual UL muting pattern. Alternatively, the UE may determine that an actual UL muting pattern may not be derived based on the provided possible UL muting pattern while meeting the condition or restriction. When a valid or applicable or allowed actual UL muting pattern can be determined by the UE, the UE applies the actual UL muting pattern to one or more REs on one or more symbols of the PUSCH transmission in the slot, else the UE may not apply an UL muting pattern and transmit the PUSCH without UL muting pattern in the slot or the UE may drop or defer the PUSCH transmission in the slot. When multiple valid or applicable or allowed actual UL muting patterns result or when multiple possible UL muting patterns are provided to the UE, a suitably selected rule can be applied to further select one of the qualifying actual UL muting patterns for the PUSCH transmission. For example, a first indexed or configured UL muting pattern may then be further selected, or a priority level may be applied to select an UL muting pattern, or an UL muting pattern resulting in a smallest or a largest number of occupied symbols by the UL resource muting may be selected.

A condition or a restriction associated with an UL muting pattern for a PUSCH in a slot may correspond to one or more of the following, a condition or a restriction with respect to a PUSCH allocation in time-domain, or with respect to a PUSCH allocation in frequency-domain, or with respect to a spatial-domain transmission parameter for a PUSCH transmission, or with respect to a provided or indicated SBFD configuration or a TDD configuration in the serving cell, or with respect to a transmission power of a PUSCH, or with respect to a PUSCH transmission format, or with respect to a reference timing.

As can be seen by someone skilled in the art, an exemplified condition or restriction can be suitably modified and applied to other cases such as when the condition or the restriction does not correspond to an inclusion but corresponds to an exclusion rule. For example, when an UL muting pattern can be applied to the PUSCH transmission in a slot under the condition or restriction that the indicted or provided PUSCH time-domain allocation with length S consecutive symbols in the slot is larger than a value TH, e.g., S>TH or not less than TH, e.g., S≥TH, otherwise the UL muting pattern is not applied, an equivalent condition or restriction can be provided as UL muting is not applied when S<TH, otherwise UL muting can be applied to the PUSCH transmission. Similarly, an exemplified condition or restriction such as S≤TH may be regarded as equivalent to S<(TH+1).

In one embodiment, the UE is provided with a condition or a restriction associated with an UL muting pattern for a PUSCH in a slot with respect to a PUSCH allocation in time-domain.

In one example, a condition or a restriction may correspond to a minimum number TH for the number of symbols S of a PUSCH time-domain allocation in a slot. The UE applies an actual or a possible UL muting pattern to the PUSCH transmission in the slot when the number S of symbols which is indicated or provided to the UE for the PUSCH time-domain allocation in the slot is equal to or larger than the minimum number TH, otherwise the UE does not apply the UL muting pattern to the PUSCH transmission in the slot.

In one example, a condition or a restriction may correspond to a maximum number TH for the number of symbols S of a PUSCH time-domain allocation in a slot. The UE applies an actual or a possible UL muting pattern to the PUSCH transmission in the slot when the number S of symbols which is indicated or provided to the UE for the PUSCH time-domain allocation in the slot is equal to or less than the maximum number TH, otherwise the UE does not apply the UL muting pattern to the PUSCH transmission in the slot.

In one example, a condition or a restriction may correspond to a range from TH1 to TH2 for the number of symbols S of a PUSCH time-domain allocation in a slot. The UE applies an actual or a possible UL muting pattern to the PUSCH transmission in the slot when the number S of symbols which is indicated or provided to the UE for the PUSCH time-domain allocation in the slot is equal to or greater than TH1 and less than or equal to TH2, otherwise the UE does not apply the UL muting pattern to the PUSCH transmission in the slot.

In one example, a condition or a restriction may correspond to a minimum starting symbol number TH for the first symbol number S of a PUSCH time-domain allocation in a slot. The UE applies an actual or a possible UL muting pattern to the PUSCH transmission in the slot when the first symbol number S of the PUSCH transmission in the slot which is indicated or provided to the UE for the PUSCH time-domain allocation in the slot is equal to or larger than the starting symbol number TH, otherwise the UE does not apply the UL muting pattern to the PUSCH transmission in the slot.

In one example, a condition or a restriction may correspond to a maximum end symbol number TH for the last symbol number T of a PUSCH time-domain allocation in a slot. The UE applies an actual or a possible UL muting pattern to the PUSCH transmission in the slot when the last symbol number T of the PUSCH transmission in the slot which is indicated or provided to the UE for the PUSCH time-domain allocation in the slot is equal to or less than the end symbol number TH, otherwise the UE does not apply the UL muting pattern to the PUSCH transmission in the slot.

In one example, a condition or a restriction may correspond to a range from TH1 to TH2 for the first and last symbol numbers S and T, respectively, of a PUSCH time-domain allocation in a slot. The UE applies an actual or a possible UL muting pattern to the PUSCH transmission in the slot when the first symbol S which is indicated or provided to the UE for the PUSCH time-domain allocation in the slot is equal to or greater than TH1 and when the last symbol number T in the PUSCH time-domain allocation of the slot is less than or equal to TH2, otherwise the UE does not apply the UL muting pattern to the PUSCH transmission in the slot.

In one example, a condition or a restriction associated with UL muting for a PUSCH transmission in a slot corresponds to an allowed or dis-allowed simultaneous UL signal or channel transmission in the slot. For example, when UL muting on a PUSCH in a slot is not allowed if an SRS transmission from the UE occurs in the slot, the UE does not apply the UL muting pattern to the PUSCH transmission in the slot and transmits the PUSCH. When UL muting on a PUSCH is allowed in a slot if an SRS transmission occurs in the slot, the UE applies the UL muting pattern to the PUSCH transmission in the slot and transmits the PUSCH. An allowed or dis-allowed simultaneous UL signal or channel transmission in a slot where UL muting for PUSCH may occur may be provided with respect to another PUSCH transmission, or a PUCCH transmission, or an SRS, or a PRACH transmission in the slot. A suitably selected time-domain gap value may be assumed by the UE, e.g., tabulated or specified in system operating specifications. or may be provided to the UE for the simultaneous UL signal or channel transmission in the slot. For example, a minimum time-domain gap value of S=2 symbols may be assumed by the UE for support of a PUSCH with UL muting when to be transmitted in a slot with respect to a preceding or a following SRS transmission in the slot.

In one example, a condition or a restriction associated with UL muting for PUSCH may be provided according to a slot or symbol type or as set of allowed or dis-allowed symbols/slots. For example, a set of symbols/slots, or a slot or symbol type, or an identifier associated with a slot or symbol, or a bitmap, or a list of symbols/slots, or a resource indicator value such as SLIV with starting slot/symbol value and a run length value in an index representation may be used to indicate or configure the UE with allowed or dis-allowed symbols/slots for UL muting. For example, when UL muting on a PUSCH in a slot is allowed if a PUSCH transmission is indicated or configured in an allowed set of slots {1, 2}, where slot indices may start with slot index 0, the UE then applies the UL muting pattern to the PUSCH transmission in the slot and transmits the PUSCH. For example, when UL muting on a PUSCH in a slot is not allowed if a PUSCH transmission is indicated or configured in a dis-allowed set of slots {3, 4}, the UE does not apply the UL muting pattern to the PUSCH transmission in the slot and transmits the PUSCH.

In one embodiment, the UE is provided with a condition or a restriction associated with an UL muting pattern for a PUSCH in a slot with respect to a PUSCH allocation in frequency-domain.

In one example, a condition or a restriction may correspond to a minimum number TH for the number of RBs S of a PUSCH frequency-domain allocation on a symbol in a slot. The UE applies an actual or a possible UL muting pattern to the PUSCH transmission in the slot when the number S of RBs which is indicated or provided to the UE for the PUSCH frequency-domain allocation on a symbol in the slot is equal to or larger than the minimum number TH, otherwise the UE does not apply the UL muting pattern to the PUSCH transmission in the slot.

In one example, a condition or a restriction may correspond to a maximum number TH for the number of RBs S of a PUSCH frequency-domain allocation on a symbol in a slot. The UE applies an actual or a possible UL muting pattern to the PUSCH transmission in the slot when the number S of RBs which is indicated or provided to the UE for the PUSCH frequency-domain allocation in the slot is equal to or less than the maximum number TH, otherwise the UE does not apply the UL muting pattern to the PUSCH transmission in the slot.

In one example, a condition or a restriction may correspond to a range from TH1 to TH2 for the number of RBs S of a PUSCH frequency-domain allocation on a symbol in a slot. The UE applies an actual or a possible UL muting pattern to the PUSCH transmission in the slot when the number S of RBs which is indicated or provided to the UE for the PUSCH frequency-domain allocation in the slot is equal to or greater than TH1 and less than or equal to TH2, otherwise the UE does not apply the UL muting pattern to the PUSCH transmission in the slot.

In one example, a condition or a restriction may correspond to a minimum starting RB number TH for the first RB number S of a PUSCH frequency-domain allocation on a symbol in a slot. The UE applies an actual or a possible UL muting pattern to the PUSCH transmission in the slot when the first RB number S of the PUSCH transmission in the slot which is indicated or provided to the UE for the PUSCH frequency-domain allocation on a symbol in the slot is equal to or larger than the starting RB number TH, otherwise the UE does not apply the UL muting pattern to the PUSCH transmission in the slot.

In one example, a condition or a restriction may correspond to a maximum end RB number TH for the last RB number T of a PUSCH frequency-domain allocation on a symbol in a slot. The UE applies an actual or a possible UL muting pattern to the PUSCH transmission in the slot when the last RB number T of the PUSCH transmission on a symbol in the slot which is indicated or provided to the UE for the PUSCH frequency-domain allocation in the slot is equal to or less than the end RB number TH, otherwise the UE does not apply the UL muting pattern to the PUSCH transmission in the slot.

In one example, a condition or a restriction may correspond to a range from TH1 to TH2 for the first and last RB numbers S and T, respectively, of a PUSCH frequency-domain allocation on a symbol in a slot. The UE applies an actual or a possible UL muting pattern to the PUSCH transmission on a symbol in the slot when the first RB number S which is indicated or provided to the UE for the PUSCH frequency-domain allocation in the slot is equal to or greater than TH1 and when the last RB number T in the PUSCH frequency-domain allocation of the slot is less than or equal to TH2, otherwise the UE does not apply the UL muting pattern to the PUSCH transmission in the slot.

In one example, a condition or a restriction associated with UL muting for a PUSCH transmission in a slot corresponds to an allowed or dis-allowed discontinuous UL transmission configuration of an UL signal or channel transmission in the slot. For example, UL muting on a PUSCH in a slot may not be allowed if PUSCH resource allocation type 1, i.e., based on RBGs, is indicated to the UE to schedule or configure a PUSCH transmission, the UE does not apply the UL muting pattern to the PUSCH transmission in the slot and transmits the PUSCH. For example, UL muting on a PUSCH may be allowed if PUSCH resource allocation type 0 is indicated to the UE to schedule or configure a PUSCH transmission, the UE applies the UL muting pattern to the PUSCH transmission in the slot and transmits the PUSCH. For example, an allowed or dis-allowed discontinuous UL signal or channel transmission in a slot where UL muting for PUSCH may occur may be provided with respect to a PUSCH transmission using multiple clusters of RBs, or for concurrent PUSCH and PUCCH transmission on a same symbol. A suitably selected frequency-domain gap value may be assumed by the UE, e.g., tabulated or specified in system operating specifications. or may be provided to the UE for the simultaneous UL signal or channel transmission in the slot. For example, a minimum frequency-domain gap value of S=5 RBs may be assumed by the UE for support of a PUSCH with UL muting in a first cluster of the PUSCH frequency-domain allocation when to be transmitted in a slot with respect to a second cluster of the PUSCH frequency-domain allocation on a symbol in the slot. For example, a starting RB, or and end RB, or a range of RBs, may be provided to the UE with respect to CRB #0.

In one example, a condition or a restriction associated with UL muting for PUSCH may be provided as set of allowed or dis-allowed RBs or RBGs. For example, a set of RBs or RBGs, e.g., a bitmap, or a list of RBs or RBGs, or a resource indicator value such as an RIV with a starting RB value and a run length value in an index representation may be used to indicate or configure the UE with allowed or dis-allowed RBs or RBGs for UL muting. For example, when UL muting on a PUSCH on a symbol in a slot is allowed if a PUSCH transmission is indicated or configured within an allowed set of RBs 10-156, where RB numbering may be with respect to a virtual resource block (VRB) or a PRB and may start with index numbering at 0, the UE then applies the UL muting pattern to the PUSCH transmission on a symbol in the slot and transmits the PUSCH. For example, when UL muting on a PUSCH on a symbol in a slot is not allowed if a PUSCH transmission is indicated or configured as partially overlapping or comprised within the RBs or RBGs corresponding to a dis-allowed set of RBs 157-273, the UE does not apply the UL muting pattern to the PUSCH transmission in the slot and transmits the PUSCH.

In one embodiment, the UE is provided with a condition or a restriction associated with an UL muting pattern for a PUSCH in a slot with respect to a spatial-domain transmission parameter for a PUSCH transmission.

For example, information may be provided to the UE by higher layers to associate a DL or UL reference signal or DL, or UL or Joint TCI state(s) or RS resource index(es) such as corresponding to an SSB or to a CSI-RS resource index with a condition or restriction for UL muting on PUSCH. For example, a TCI state or an RS resource index may be associated with one or more conditions for UL muting on PUSCH, or more than one UL muting pattern or PUSCH configuration may be associated with a TCI state or RS resource index.

In one example, a first TCI state or RS resource index may correspond to a PUSCH transmission for which UL muting can be applied by the UE or for which UL muting is allowed or supported, and a second TCI state or RS resource index may correspond to a PUSCH transmission for which UL muting should not be applied by the UE or for which UL muting is not allowed or not supported. The UE determines an applicable spatial transmission parameter for the PUSCH transmission based on the first or a second TCI state or the first or the second RS resource index. The UE applies an actual or a possible UL muting pattern to the PUSCH transmission in the slot when the first TCI state or first RS resource index is selected, otherwise, e.g., when the second TCI state or the second RS resource index is selected, the UE does not apply the UL muting pattern to the PUSCH transmission in the slot.

For example, information may be provided to the UE by higher layers to associate a TRP such as corresponding to a CORESETPOOLIndex with a condition or restriction for UL muting on PUSCH. For example, a cell may include more than one TRP. For example, mTRP operation may be referred to as intra-cell mTRP operation. In one example, a TRP may be identified by a CORESETPOOLIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) channel state information reference signal (CSI-RS) resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on. In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples. In one example, a TRP may be identified by a group (e.g., one or more) sounding reference signal (SRS) resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on. For conciseness of description, mTRP operation using TRPs associated with different CORESETPOOLIndex or different TCI states lists are used in the following examples. As can be seen, solutions based on association of TRPs with SSBs or CSI-RS resources sets may be regarded as equivalent.

In one example, a first CORESETPOOLIndex may correspond to a PUSCH transmission for which UL muting can be applied by the UE (e.g., the UE 116) or for which UL muting is allowed or supported, and a second CORESETPOOLIndex may correspond to a PUSCH transmission for which UL muting should not be applied by the UE or for which UL muting is not allowed or not supported. The UE may be provided with an UL grant or with a configured grant for a PUSCH transmission. For example, the UE may determine a CORESETPOOLIndex corresponding to a received DCI format scheduling a PUSCH transmission. The UE applies an actual or a possible UL muting pattern to the PUSCH transmission in the slot when the first CORESETPOOLIndex is selected, otherwise, e.g., when the second CORESETPOOLIndex is selected, the UE does not apply the UL muting pattern to the PUSCH transmission in the slot. Similar implementations can be applied when a TRP is associated or identified to a first and a second PUSCH transmission format, with and without UL muting, or with different UL muting patterns, respectively, based on a method other than the CORESETPOOLIndex.

In one example, a condition or a restriction may correspond to a set of allowed or dis-allowed antenna port numbers or a minimum or a maximum number of spatial layers, or to a set of layers, or to a set of allowed or dis-allowed precoders, or codebooks for UL muting on PUSCH. For example, an allowed or dis-allowed port mapping, or layer mapping, or precoding, or codebook may be provided to the UE by higher layer signaling, or indicated to the UE by DCI or MAC-CE signaling, or may be tabulated or specified using system operating descriptions. For example, the UE may determine or select an UL muting pattern for a PUSCH transmission in a slot based on an indication received in a precoding or antenna port field in an UL grant DCI format such as 0_0, 0_1 or 0_3.

In one example, a condition or a restriction may correspond to a maximum number of layers TH for the number of spatial layers S of a PUSCH allocation in a slot. The UE applies an actual or a possible UL muting pattern to the spatial layers for the PUSCH transmission in the slot when the number S of spatial layers which is indicated or provided to the UE for the PUSCH allocation in the slot is equal to or less than the maximum number TH, otherwise the UE does not apply the UL muting pattern to the PUSCH transmission in the slot. Similar implementations can then be applied to cases such as when a minimum number of layers or a set of allowed or dis-allowed spatial layers for mapping of an UL muting pattern in the PUSCH transmission is provided to the UE.

In one embodiment, the UE is provided with a condition or a restriction associated with an UL muting pattern for a PUSCH in a slot with respect to a provided or indicated SBFD configuration or a TDD configuration in the serving cell.

For example, the UE may determine or select or adjust an actual or a possible UL muting pattern for a PUSCH transmission in a slot based on one or more of the following conditions or restrictions:
A symbol or slot type, e.g., symbol/slot of type ‘SBFD’, or of type ‘non-SBFD’, or symbol/slot type ‘D’ or ‘F’ or ‘U’;
A number or a time-domain-location of SBFD symbols in a slot, e.g., a maximum or minimum number of consecutive SBFD symbols or within a range of symbols;
An SBFD subband type, e.g., SBFD DL subband and/or SBFD UL subband and/or first SBFD DL subband and/or second SBFD DL subband and/or SBFD flexible subband;
A size or a frequency-domain location of an SBFD subband, e.g., SBFD UL subband with a size smaller or larger than a number of RBs, an SBFD UL subband within a range of RBs, or an SBFD UL subband location with respect to the NR carrier grid or CRB #0;
A type or an identifier of an SBFD configuration, e.g., ‘DU’, or ‘UD’, or ‘DUD’.

In one example, a condition or a restriction may correspond to a minimum number TH for the number of symbols S of SBFD time-domain configuration in a slot. The UE applies an actual or a possible UL muting pattern to the PUSCH transmission in the slot when the number S of symbols which is indicated or provided to the UE for the SBFD time-domain configuration in the slot is equal to or larger than the minimum number TH, otherwise the UE does not apply the UL muting pattern to the PUSCH transmission in the slot.

In one example, a condition or a restriction may correspond to a maximum number TH for the number of symbols S of an SBFD time-domain configuration in a slot. The UE applies an actual or a possible UL muting pattern to the PUSCH transmission in the slot when the number S of symbols which is indicated or provided to the UE for the SBFD time-domain configuration in the slot is equal to or less than the maximum number TH, otherwise the UE does not apply the UL muting pattern to the PUSCH transmission in the slot.

In one example, a condition or a restriction may correspond to a range from TH1 to TH2 for the number of symbols S of an SBFD time-domain configuration in a slot. The UE applies an actual or a possible UL muting pattern to the PUSCH transmission in the slot when the number S of symbols which is indicated or provided to the UE for the SBFD time-domain configuration in the slot is equal to or greater than TH1 and less than or equal to TH2, i.e., the PUSCH time-domain allocation in a slot is comprised by the SBFD time-domain configuration in the slot, otherwise the UE does not apply the UL muting pattern to the PUSCH transmission in the slot.

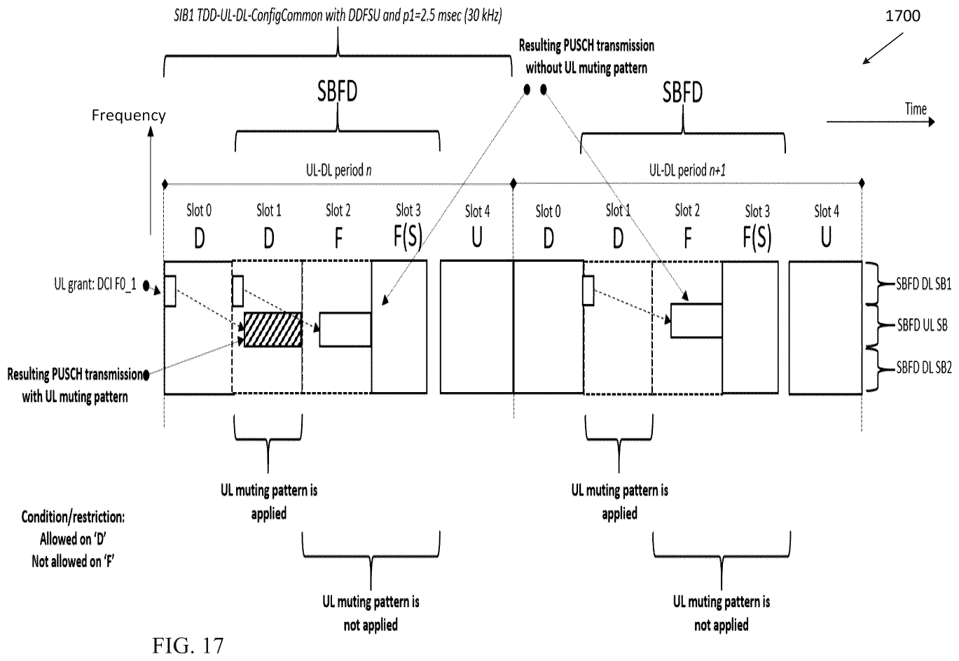

FIG. 17 illustrates a timeline 1700 of an example UL muting pattern according to embodiments of the present disclosure. For example, timeline 1700 can be followed by any of the UEs 111-116 and the gNB 102 and/or network 130 in the wireless network 100 of FIG. 1. This example is for illustration only and other embodiments can be used without departing from the scope of the present disclosure.

In one example, a condition or a restriction may correspond to a symbol or slot type provided by higher layer parameter TDD-UL-DL-ConfigCommon in SIB1 or a parameter ServingCellConfigCommon. For example, a parameter ulMutingSymbolType may be provided to the UE in a SIB1 or by ServingCellConfigCommon for indication to the UE that UL muting is applied or not applied as condition or restriction to a PUSCH transmission on an indicated or a not indicated symbol type in one or more symbol(s) configured as UL muting resource. For example, a parameter ulMutingSymbolType may correspond to an indication of a symbol or slot type such as ‘SBFD’ or ‘non-SBFD’, or a symbol or slot type such as ‘D’ or ‘F’ or ‘U’, or a combination thereof. For example, a parameter ulMutingSymbolType may indicate to the UE to apply UL resource muting to non-SBFD symbols if SBFD symbols are configured for the UE. For example, when the parameter ulMutingSymbolType is set or enabled, the UE then applies UL muting in both SBFD symbols and non-SBFD symbols, otherwise, when the parameter ulMutingSymbolType is not provided or is not enabled, the UE applies UL muting in SBFD symbols. For example, a parameter ulMutingSymbolType may correspond to a bit or a flag or an information element such as ulMutingNonSBFDSymbol. For example, a parameter ulMutingSymbolType may indicate to the UE to apply UL resource muting to flexible symbols. For example, when the parameter ulMutingSymbolType is set or enabled, the UE then applies UL muting in both UL symbols and flexible symbols, otherwise, when the parameter ulMutingSymbolType is not provided or is not enabled, the UE applies UL muting in UL symbols. For example, a parameter ulMutingSymbolType may correspond to a bit or flag or information element such as ulMutingFlexibleSymbol.

The UE determines or selects or adjusts an actual or a possible UL muting pattern for PUSCH based on the slot or symbol type. The UE applies an actual or a possible UL muting pattern to the PUSCH transmission in the slot or symbol on an SBFD slot or symbol when the slot or symbol type corresponds to ‘D’, otherwise the UE does not apply the UL muting pattern to the PUSCH transmission in the slot.

In one example, a condition or a restriction may correspond to a minimum number TH for the number of RBs S of an SBFD UL subband size on a symbol in a slot. The UE applies an actual or a possible UL muting pattern to the PUSCH transmission in the slot when the number S of RBs which is indicated or provided to the UE for the SBFD UL subband on a symbol in the slot is equal to or larger than the minimum number TH, otherwise the UE does not apply the UL muting pattern to the PUSCH transmission in the slot.

In one example, a condition or a restriction may correspond to a maximum number TH for the number of RBs S of SBFD UL subband size on a symbol in a slot. The UE applies an actual or a possible UL muting pattern to the PUSCH transmission in the slot when the number S of RBs which is indicated or provided to the UE for the SBFD UL subband in the slot is equal to or less than the maximum number TH, otherwise the UE does not apply the UL muting pattern to the PUSCH transmission in the slot.

In one example, a condition or a restriction may correspond to a range from TH1 to TH2 for the number of RBs S of a PUSCH frequency-domain allocation within an SBFD UL subband on a symbol in a slot. The UE applies an actual or a possible UL muting pattern to the PUSCH transmission in the SBFD UL subband in the slot when the number S of RBs which is indicated or provided to the UE for the PUSCH frequency-domain allocation in the slot is equal to or greater than TH1 and less than or equal to TH2, otherwise the UE does not apply the UL muting pattern to the PUSCH transmission in the SBFD UL subband in the slot.

In one embodiment, the UE is provided with a condition or a restriction associated with an UL muting pattern for a PUSCH in a slot with respect to a transmission power of a PUSCH.

For example, a transmission power of a PUSCH may be determined based on one or a combination of the following: a UE maximum output power, and/or a PCMAX, f, c value, and/or an MPR value such as A-MPR or P-MPR, and/or open-loop power control parameters, and/or closed-loop power control components.

In one example, a condition or a restriction may correspond to a minimum UL transmission power TH for the PUSCH transmission in a slot. The UE applies an actual or a possible UL muting pattern to the PUSCH transmission in the slot when a configured or actual UL transmission power for the PUSCH transmission in the slot is equal to or larger than the minimum UL transmission power TH, otherwise the UE does not apply the UL muting pattern to the PUSCH transmission in the slot.

In one example, a condition or a restriction may correspond to a maximum UL transmission power TH for the PUSCH transmission in a slot. The UE applies an actual or a possible UL muting pattern to the PUSCH transmission in the slot when a configured or actual UL transmission power for the PUSCH transmission in the slot is equal to or less than the maximum UL transmission power TH, otherwise the UE does not apply the UL muting pattern to the PUSCH transmission in the slot.

In one example, a condition or a restriction may correspond to a range of UL transmission power TH1 to TH2 for the PUSCH transmission in a slot. The UE applies an actual or a possible UL muting pattern to the PUSCH transmission in the slot when a configured or actual UL transmission power for the PUSCH transmission in the slot is equal to or greater than TH1 and less than or equal to TH2, otherwise the UE does not apply the UL muting pattern to the PUSCH transmission in the slot.

In one embodiment, the UE is provided with a condition or a restriction associated with an UL muting pattern for a PUSCH in a slot with respect to a PUSCH transmission format.

For example, a PUSCH transmission format may correspond to one or a combination of the following, an RB allocation, a symbol allocation, a modulation scheme, a modulation order, an MCS, a TBS, a channel coding type or rate, a payload type such as data or UCI/control, a UCI/control payload type such as A/N, or CSI, or CSI part 1, or CSI part 2, or a UCI/control reporting type such as periodic, or semi-persistent, or aperiodic CSI report in the control payload.

In one example, a condition or a restriction may correspond to a minimum MCS level TH for the PUSCH transmission in a slot. The UE applies an actual or a possible UL muting pattern to the PUSCH transmission in the slot when the MCS for the PUSCH transmission in the slot is equal to or larger than the minimum UL MCS level TH, otherwise the UE does not apply the UL muting pattern to the PUSCH transmission in the slot.

In one example, a condition or a restriction may correspond to a maximum MCS level TH for the PUSCH transmission in a slot. The UE applies an actual or a possible UL muting pattern to the PUSCH transmission in the slot when the MCS for the PUSCH transmission in the slot is equal to or smaller than the maximum UL MCS level TH, otherwise the UE does not apply the UL muting pattern to the PUSCH transmission in the slot.

In one example, a condition or a restriction may correspond to a channel coding range TH1 to TH2 for the PUSCH transmission in a slot. The UE applies an actual or a possible UL muting pattern to the PUSCH transmission in the slot when the determined channel coding rate corresponding to the TB of the PUSCH transmission in the slot is equal to or greater than TH1 and less than or equal to TH2, otherwise the UE does not apply the UL muting pattern to the PUSCH transmission in the slot. For example, TH1 may be set to 0 or TH2 may correspond to a maximum number of bits of a code block.

In one example, a condition or a restriction may correspond to a TBS range TH1 to TH2 for the PUSCH transmission in a slot. The UE applies an actual or a possible UL muting pattern to the PUSCH transmission in the slot when the determined TBS size of a TB of the PUSCH transmission in the slot is equal to or greater than TH1 and less than or equal to TH2, otherwise the UE does not apply the UL muting pattern to the PUSCH transmission in the slot. For example, TH1 may be set to a minimum TBS size and TH2 may correspond to a maximum number of bits for a TB.

In one example, a condition or a restriction may correspond to a modulation scheme such as CP-OFDM or DFTS-OFDM for the PUSCH transmission in a slot. The UE applies an actual or a possible UL muting pattern to the PUSCH transmission in the slot when the indicated or determined modulation scheme of the PUSCH transmission in the slot corresponds to a modulation scheme for which the UE supports UL muting on PUSCH, otherwise the UE does not apply the UL muting pattern to the PUSCH transmission in the slot. For example, the UE may support UL muting for a PUSCH transmission using CP-OFDM as modulation scheme and may not support UL muting for a PUSCH transmission using DFTS-OFDM as modulation scheme. The UE then applies UL muting to the PUSCH transmission when CP-OFDM is indicated or determined as the modulation scheme and does not apply UL muting to the PUSCH transmission when DFTS-OFDM is indicated or determined as the modulation scheme.

In one example, a condition or a restriction may correspond to UCI/control payload type for the PUSCH transmission in a slot. The UE applies an actual or a possible UL muting pattern to the PUSCH transmission in the slot when the UCI/control payload type is CSI or CSI part 1 or CSI part 2 for the PUSCH transmission in the slot, otherwise, e.g., when the UCI/payload type is A/N, the UE does not apply the UL muting pattern to the PUSCH transmission in the slot.

In one embodiment, the UE is provided with a condition or a restriction associated with an UL muting pattern for a PUSCH in a slot with respect to a reference timing.

A UE may be provided with information for a reference timing associated with UL muting on PUSCH. For example, a reference timing may correspond to one or more of the following: a start timing, or an end timing, or a duration, or an application timing, or a validity period.

In one example, a condition or a restriction may correspond to an application timing TH to apply an UL muting pattern for a PUSCH transmission in a slot. The UE applies an actual or a possible UL muting pattern to a PUSCH transmission in a slot when the UL grant corresponding to a PUSCH transmission with an UL muting pattern is received at least TH msec or TH symbols earlier than a first symbol of the PUSCH, otherwise the UE does not apply the UL muting pattern to the PUSCH transmission in the slot.

In one example, a condition or a restriction may correspond to validity period S to apply an UL muting pattern for a PUSCH transmission in a slot. The UE applies a second actual or a possible UL muting pattern to a PUSCH transmission in a slot when a first actual or possible UL muting pattern corresponding to a PUSCH transmission with UL muting was indicated or provided to the UE earlier than TH msec or TH symbols than a first symbol of the PUSCH, otherwise the UE does not apply the UL muting pattern to the PUSCH transmission in the slot.

One motivation for a condition or a restriction associated with UL muting for PUSCH is that a modem complexity can be reduced. For example, when UL muting for PUSCH can only be applied to a PUSCH for a number of symbols larger than a minimum number of symbols, a resulting RE mapping and/or TBS size determination are simplified, and/or an impact to control/data multiplexing in the modem rate-matching chain can be reduced, and the UE and/or gNB (e.g., the BS 102) implementation is simplified accordingly. For example, when an actual or a possible UL muting pattern is restricted to PUSCH allocations not exceeding a certain size or frequency-domain location, e.g., number of RBs, with respect to the size of the UL BWP or the size of the SBFD UL subband, less filtering may be required; which can reduce MPR values and improve the UL coverage accordingly. Similar implementations can be applied to a restriction of a minimum or a maximum modulation order for a PUSCH transmission with UL muting. This is because UL muting, e.g., not transmitting certain REs on certain symbols of a PUSCH in the UL transmission BW becomes more complex in the UE and/or gNB modem implementation for higher modulation orders such as 64 QAM.

As can be seen by someone skilled in the art, examples herein can be generalized to other cases such as when the UE selects an actual UL muting pattern for a scheduled or configured PUSCH transmission in a slot based on a set of provided possible UL muting patterns and based on a provided condition or restriction or such as when the UE determines an actual UL muting pattern for a scheduled or configured PUSCH transmission in a slot based on a provided possible UL muting pattern and based on a provided condition or restriction.

In one example, a condition or a restriction may correspond to a range from TH1 to TH2 for the first and last symbol numbers S and T, respectively, of a PUSCH time-domain allocation in a slot. For example, the UE can apply an actual or a possible UL muting pattern to the PUSCH transmission in the slot when the first symbol S which is indicated or provided to the UE for the PUSCH time-domain allocation in the slot is equal to or greater than TH1 and when the last symbol number T in the PUSCH time-domain allocation of the slot is less than or equal to TH2, otherwise the UE does not apply the UL muting pattern to the PUSCH transmission in the slot. For example, the UE can select an actual from two possible UL muting patterns provided for a PUSCH transmission in the slot. A separate value for TH1 and TH2, respectively may be provided to the UE for a first and a second possible UL muting pattern. A first or a second possible UL muting pattern may be selected by the UE, when the first symbol S which is indicated or provided to the UE for the PUSCH time-domain allocation in the slot is equal to or greater than TH1 and when the last symbol number T in the PUSCH time-domain allocation of the slot is less than or equal to TH2, respectively, the UE then applies the selected or actual UL muting pattern to the PUSCH transmission in the slot; else if no possible UL muting pattern can be selected, the UE may transmit the PUSCH without UL muting.

In one example, a condition or a restriction may correspond to UCI/control payload type A/N for the PUSCH transmission in a slot. For example, UE can apply an actual or a possible UL muting pattern to the PUSCH transmission in the slot when the UCI/control payload type is A/N on a symbol of the PUSCH transmission in the slot, or otherwise, e.g., the UE does not apply the UL muting pattern to the symbol of the PUSCH transmission in the slot. For example, when A/N is present on a symbol of the PUSCH with a possible UL muting pattern on the symbol, the UE may determine an actual UL muting pattern for a scheduled or configured PUSCH transmission in a slot based on the provided possible UL muting pattern and based on a provided condition or restriction, e.g., UL muting is not applied to the symbol of the PUSCH carrying A/N, and a next UL muting symbol may be determined by the UE.

In one embodiment, the UE indicates or reports a condition or restriction associated with a PUSCH transmission capability when UL muting is supported on a carrier or in a band in the UE capability signaling.

For example, a condition or a restriction associated with a PUSCH transmission capability when UL muting is supported in a slot may correspond to one or more of the following, a condition or a restriction with respect to a PUSCH allocation in time-domain, or with respect to a PUSCH allocation in frequency-domain, or with respect to a spatial-domain transmission parameter for a PUSCH transmission, or with respect to a provided or indicated SBFD configuration or a TDD configuration in the serving cell, or with respect to a transmission power of a PUSCH, or with respect to a PUSCH transmission format, or with respect to a reference timing.

In one example, a condition or a restriction associated with a PUSCH transmission capability when UL muting is supported may correspond to the minimum number TH for the number of symbols S of a PUSCH time-domain allocation in a slot. The UE indicates or reports support for UL muting in the PUSCH transmission in the slot when the number S of symbols which are indicated or provided to the UE for the PUSCH time-domain allocation in the slot is equal to or larger than the minimum number TH, otherwise the UE does not support UL muting for the PUSCH transmission in the slot.

In one example, a condition or a restriction associated with a PUSCH transmission capability when UL muting is supported may correspond to a minimum number TH for the number of RBs S of an SBFD UL subband size on a symbol in a slot. The UE indicates or reports support for UL muting in the PUSCH transmission in the slot when the number S of RBs which is indicated or provided to the UE for the SBFD UL subband on a symbol in the slot is equal to or larger than the minimum number TH, otherwise the UE does not support UL muting for the PUSCH transmission in the slot.

In one example, a condition or a restriction associated with a PUSCH transmission capability when UL muting is supported may correspond to a PUSCH transmission format such as a modulation scheme for which the UE supports UL muting. For example, a supported or a not supported modulation scheme may correspond to CP-OFDM or DFTS-OFDM. The UE indicates or reports support for UL muting in a PUSCH transmission in a slot when an indicated or determined modulation scheme of the PUSCH transmission corresponds to CP-OFDM, or indicates or reports support for UL muting in a PUSCH when an indicated or determined modulation scheme of the PUSCH transmission corresponds to DFTS-OFDM. For example, the UE may indicate or report an associated UE capability for support of UL muting according to a modulation scheme for either one or both modulation schemes.

In one example, a condition or a restriction associated with a PUSCH transmission capability when UL muting is supported may correspond to a UCI/control payload type for the PUSCH transmission in a slot. The UE indicates or reports support for UL muting on a symbol of the PUSCH transmission in the slot when the UCI/control payload type on the symbol of the PUSCH transmission is CSI or A/N. For example, the UE may report or indicate that UCI/control payload type CSI and UL muting on the symbol is not supported for PUSCH transmissions, or the UE may report or indicate that UCI/control payload type A/N and UL muting on the symbol is supported for PUSCH transmissions.

As can be seen by someone skilled in the art, examples herein can be generalized to other a condition or a restriction associated with a PUSCH transmission capability when UL muting is supported in a slot corresponding to other conditions or restrictions with respect to a PUSCH allocation in time-domain, or with respect to a PUSCH allocation in frequency-domain, or with respect to a spatial-domain transmission parameter for a PUSCH transmission, or with respect to a provided or indicated SBFD configuration or a TDD configuration in the serving cell, or with respect to a transmission power of a PUSCH, or with respect to a PUSCH transmission format, or with respect to a reference timing.

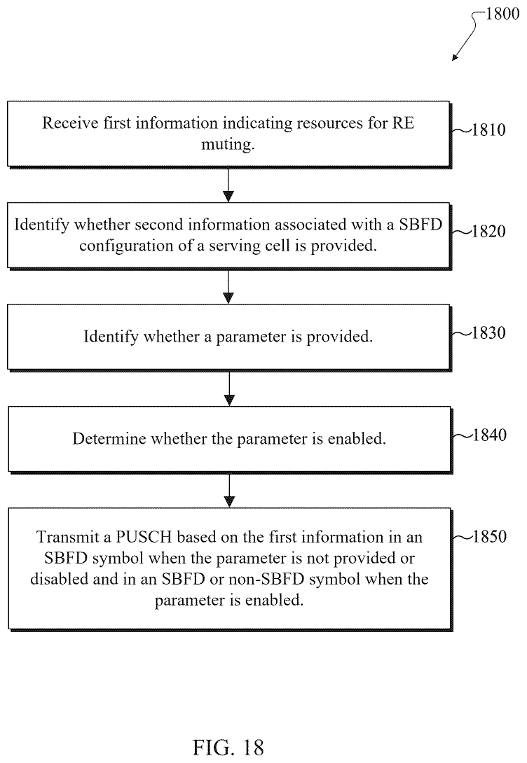

FIG. 18 illustrates an example method 1800 performed by a UE in a wireless communication system according to embodiments of the present disclosure. The method 1800 of FIG. 18 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1800 is for illustration only and other embodiments can be used without departing from the scope of the present disclosure.

The method 1800 begins with the UE receiving first information indicating resources for RE muting (1810). In various embodiments, the first information is included in an entry of a TDRA and the entry indicates whether to apply RE muting on a symbol of a PUSCH in a slot.

The UE then identifies whether second information associated with a SBFD configuration of a serving cell is provided (1820). In various embodiments, when the second information is not provided, the UE determines to apply RE muting to a symbol of the PUSCH on a symbol or slot type including uplink (UL) or flexible (F).

The UE then identifies whether a parameter is provided (1830). For example, in 1830, the parameter is ulMutingNonSBFDSymbol. The UE then determines whether the parameter is enabled (1840).

The UE then transmits a PUSCH based on the first information in an SBFD symbol when the parameter is not provided or disabled and in an SBFD or non-SBFD symbol when the parameter is enabled (1850). In various embodiments, the UE determines a condition corresponding to a minimum or maximum UL transmit power level and determines to apply RE muting to a symbol of the PUSCH when a UL transmit power of the PUSCH is greater or equal to the minimum UL transmit power level or the UL transmit power of the PUSCH is not larger than the maximum UL transmit power level. In various embodiments, the UE applies RE muting to a symbol of the PUSCH when RB allocation of the PUSCH is greater or equal to a minimum RB allocation or the RB allocation of the PUSCH is not larger than a maximum RB allocation. In various embodiments, the UE applies RE muting to a symbol of the PUSCH when a number of symbols of a time-domain resource allocation of the PUSCH is greater or equal to a minimum number of symbols or not larger than a maximum number of symbols. In various embodiments, the UE applies RE muting to a symbol of the PUSCH when the symbol does not include UCI and does not apply RE muting to the symbol when the symbol includes UCI.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE) to transmit a physical uplink shared channel (PUSCH), the method comprising:
receiving first information indicating resources for resource element (RE) muting;
identifying whether second information associated with a subband full duplex (SBFD) configuration of a serving cell is provided;
identifying whether a parameter is provided, wherein the parameter is ulMutingNonSBFDSymbol;
determining whether the parameter is enabled; and
transmitting the PUSCH based on the first information:
in an SBFD symbol when the parameter is not provided or disabled, and
in an SBFD or non-SBFD symbol when the parameter is enabled.

2. The method of claim 1, further comprising, when the second information is not provided, determining to apply RE muting to a symbol of the PUSCH on a symbol or slot type including uplink (UL) or flexible (F).

3. The method of claim 1, wherein:
the first information is included in an entry of a time-domain resource allocation table (TDRA), and
the entry indicates whether to apply RE muting on a symbol of the PUSCH in a slot.

4. The method of claim 1, further comprising:
determining a condition corresponding to a minimum or maximum uplink (UL) transmit power level; and
determining to apply RE muting to a symbol of the PUSCH when (i) a UL transmit power of the PUSCH is greater or equal to the minimum UL transmit power level or (ii) the UL transmit power of the PUSCH is not larger than the maximum UL transmit power level.

5. The method of claim 1, further comprising applying RE muting to a symbol of the PUSCH when (i) resource block (RB) allocation of the PUSCH is greater or equal to a minimum RB allocation or (ii) the RB allocation of the PUSCH is not larger than a maximum RB allocation.

6. The method of claim 1, further comprising applying RE muting to a symbol of the PUSCH when a number of symbols of a time-domain resource allocation of the PUSCH is (i) greater or equal to a minimum number of symbols or (ii) not larger than a maximum number of symbols.

7. The method of claim 1, further comprising:
applying RE muting to a symbol of the PUSCH when the symbol does not include uplink control information (UCI); and
not applying RE muting to the symbol when the symbol includes UCI.

8. A user equipment (UE), comprising:
a transceiver configured to receive first information indicating resources for resource element (RE) muting; and
a processor operably coupled with the transceiver, the processor configured to:
identify whether second information associated with a subband full duplex (SBFD) configuration of a serving cell is provided;
identify whether a parameter is provided, wherein the parameter is ulMutingNonSBFDSymbol; and
determine whether the parameter is enabled,
wherein the transceiver is further configured to transmit a physical uplink shared channel (PUSCH) based on the first information:
in an SBFD symbol when the parameter is not provided or disabled, and
in an SBFD or non-SBFD symbol when the parameter is enabled.

9. The UE of claim 8, wherein the processor is further configured to, when the second information is not provided, determine to apply RE muting to a symbol of the PUSCH on a symbol or slot type including uplink (UL) or flexible (F).

10. The UE of claim 8, wherein:
the first information is included in an entry of a time-domain resource allocation table (TDRA), and
the entry indicates whether to apply RE muting on a symbol of the PUSCH in a slot.

11. The UE of claim 8, wherein the processor is further configured to:
determine a condition corresponding to a minimum or maximum uplink (UL) transmit power level; and
determine to apply RE muting to a symbol of the PUSCH when (i) a UL transmit power of the PUSCH is greater or equal to the minimum UL transmit power level or (ii) the UL transmit power of the PUSCH is not larger than the maximum UL transmit power level.

12. The UE of claim 8, wherein the processor is further configured to apply RE muting to a symbol of the PUSCH when (i) resource block (RB) allocation of the PUSCH is greater or equal to a minimum RB allocation or (ii) the RB allocation of the PUSCH is not larger than a maximum RB allocation.

13. The UE of claim 8, wherein the processor is further configured to apply RE muting to a symbol of the PUSCH when a number of symbols of a time-domain resource allocation of the PUSCH is (i) greater or equal to a minimum number of symbols or (ii) not larger than a maximum number of symbols.

14. The UE of claim 8, wherein the processor is further configured to:
apply RE muting to a symbol of the PUSCH when the symbol does not include uplink control information (UCI); and
not apply RE muting to the symbol when the symbol includes UCI.

15. A base station (BS), comprising:
a transceiver configured to transmit first information indicating resources for resource element (RE) muting; and
a processor operably coupled with the transceiver, the processor configured to:
identify whether second information associated with a subband full duplex (SBFD) configuration of a serving cell is provided;
identify whether a parameter is provided, wherein the parameter is ulMutingNonSBFDSymbol; and
determine whether the parameter is enabled,
wherein the transceiver is further configured to receive a physical uplink shared channel (PUSCH) based on the first information:
in an SBFD symbol when the parameter is not provided or disabled, and
in an SBFD or non-SBFD symbol when the parameter is enabled.

16. The BS of claim 15, wherein the processor is further configured to, when the second information is not provided, determine that RE muting is applied to a symbol of the PUSCH on a symbol or slot type including uplink (UL) or flexible (F).

17. The BS of claim 15, wherein:
the first information is included in an entry of a time-domain resource allocation table (TDRA), and
the entry indicates whether to apply RE muting on a symbol of the PUSCH in a slot.

18. The BS of claim 15, wherein the processor is further configured to:
determine a condition corresponding to a minimum or maximum uplink (UL) transmit power level; and
determine that RE muting is applied to a symbol of the PUSCH when (i) a UL transmit power of the PUSCH is greater or equal to the minimum UL transmit power level or (ii) the UL transmit power of the PUSCH is not larger than the maximum UL transmit power level.

19. The BS of claim 15, wherein the processor is further configured to determine that RE muting is applied to a symbol of the PUSCH when (i) resource block (RB) allocation of the PUSCH is greater or equal to a minimum RB allocation or (ii) the RB allocation of the PUSCH is not larger than a maximum RB allocation.

20. The BS of claim 15, wherein the processor is further configured to determine that RE muting is applied to a symbol of the PUSCH when a number of symbols of a time-domain resource allocation of the PUSCH is (i) greater or equal to a minimum number of symbols or (ii) not larger than a maximum number of symbols.
